(19) United States
(12) Patent Application Publication
(10) Pub. No.: US 2008/0134757 A1
(43) Pub. Date: Jun. 12, 2008

(54) Method And Apparatus For Monitoring Plasma Conditions In An Etching Plasma Processing Facility

(75) Inventors: Ing-Shin Chen, Danbury, CT (US); Jeffrey W. Neuner, Bethel, CT (US); Frank Dimeo, Falls Church, VA (US); Philip S.H. Chen, Bethel, CT (US); James J. Welch, Clayton, NC (US); Jeffrey F. Roeder, Brookfield, CT (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 11/908,668

(22) PCT Filed: Mar. 15, 2006
(86) PCT No.: PCT/US2006/009330

§ 371 Date: Jan. 9, 2008

Related U.S. Application Data
(63) Continuation of application No. 11/081,439, filed on Mar. 16, 2005.

(51) Int. Cl. G01N 25/36

(52) U.S. Cl. 73/25.05

(57) ABSTRACT

A gas sensor and method of gas sensing, e.g., of a type as useful with downstream sensor elements for determining the plasma conditions (e.g., plasma etching end point) in a semiconductor etching facility that utilizes halogen-containing plasma and/or oxygen-containing plasma. Such sensor elements are capable of exhibiting temperature change in the presence of energetic gas species, e.g., fluorine, chlorine, iodine, bromine, oxygen, and derivatives and radicals thereof that are generated by the plasma, and correspondingly generating an output signal indicative of such temperature change for determination of the plasma conditions in the etching plasma processing facility.

### BACKGROUND OF THE INVENTION

1. Field of the Invention

The present invention relates generally to a method and a system for determining plasma conditions in an etching plasma processing facility, by sensing one or more energetically active gas species, such as fluorine, chlorine, iodine, bromine, oxygen, and derivatives or radicals thereof that have been energetically activated for etching purposes, at a location downstream of such etching plasma processing facility.

In a specific aspect, the invention relates to a device and a method for sensing fluoro or halogen species, which have utility for monitoring of fluorine-containing compounds and ionic species in semiconductor process operations.

2. Description of the Related Art

In the manufacture of semiconductor devices, the deposition of silicon (Si) and silicon dioxide (SiO₂), and subsequent etching, are vital operational steps that currently comprise 8˜10 steps or roughly 25% of the total manufacturing process. Each deposition tool and etch tool must undergo a periodic cleaning procedure, sometimes as often as every run, in order to ensure uniform and consistent film properties.

Etching plasma has been widely used in semiconductor industry for etching and chemical vapor deposition (CVD) cleaning purposes. The plasma is utilized as an energy medium to generate highly reactive species by breaking apart gas molecules from the feedstock, and such highly reactive species scavenge the materials either on the wafer or the chamber wall to form volatile reaction products that can be easily removed.

Currently in etching operations, etch endpoints are reached when a prescribed amount of time has elapsed. Over etch, in which the process gas continues to flow into the reactor chamber after the cleaning etch is finished, is common and leads to longer process cycles, reduced tool lifetimes, and unnecessary release of fluoro species or other global warming gases to the atmosphere.

Similar issues are present in the etching of silicon nitride, tantalum oxide (Ta₂O₅), or silicon-based low dielectric constant materials (e.g., C- and/or F-doped SiO₂).

Various analytical techniques, such as Langmuir probes, FTIR, optical emission spectroscopy, and ionized mass spectroscopy, have been used to monitor the etching process.

However, these techniques tend to be expensive, and often require a dedicated operator due to their complexity. Further, they are generally considered impractical for in-line adoption for continuous monitoring due to their operational constraints.

A simple low cost, reliable sensor alternative is desired, which is useful for semiconductor process control, as well as in life safety and room monitoring applications, and other industrial process gas sensing applications.

It would therefore be a significant advance in the art to provide a reliable, low-cost sensing method and apparatus that will serve to improve the throughput and chemical efficiency of the equipment used for the deposition and etching of silicon-containing materials, including silicon, silicon nitride and silicon dioxide, and for monitoring the etching and cleaning process, by reducing and optimizing clean and etch times, and hence reducing chemical usage, lengthening equipment operating life, and decreasing equipment down time.

U.S. Patent Application Publication No. 20040074285 published Apr. 22, 2004 for “APPARATUS AND PROCESS FOR SENSING FLUORO SPECIES IN SEMICONDUCTOR PROCESSING SYSTEMS” discloses an apparatus and method for sensing solid-state fluoro or halogen species, using a fluoro- or halogen-reactive metal filament woven around metal packaging posts or Vespel® polyimide blocks on a KF flange. Detection of the fluoro species using such metal filament-based sensors relies on monitoring the resistance changes in the metal filaments caused by their reactions with the fluorine-containing compounds. In order to ensure acceptable sensitivity and signal-to-noise ratio for such metal filament-based sensors, the dimensions and the positions of the metal filaments are controlled and optimized via uses of the metal packaging posts or the Vespel® polyimide blocks, and the absolute resistance of such metal filaments are therefore adequate for endpoint detection.

However, the Vespel® structures and/or the metal packaging posts, when used in conjunction with the metal filament sensors, may form a heat sink that reduces the signal strength of the sensor elements. Further, fabrication of the 3-dimensional sensor packages containing the metal filaments, the metal posts and/or Vespel® blocks on the KF flange is relatively labor intensive.

One type of sensor that has been developed for monitoring etching species in microelectronic device manufacturing and other industrial operation, is the pellistor catalytic gas detector. In this device, a small-diameter wire coil, formed of a suitable material such as platinum, is reposed on a support of a refractory material on which a catalytic material is deposited. The resulting assembly is heated to elevated temperature, e.g., on the order of about 500° C., and the monitored species in the gas undergoing monitoring is catalytically oxidized by the catalytic material on the support.

During the sensing operation, the heat of combustion of the species of interest is transmitted to the wire coil and a calorimetric sensing involving such coil then yields a determination of the presence of the gas species of interest, or conversely, its absence in the gas stream being monitored when catalytic oxidation of such as species is no longer taking place.

In such manner, the pellistor can be usefully employed as a monitor for detection of fluorine in gas streams susceptible to the presence of same. One such pellistor includes a micromachined nickel wire assembly on a silicon carbide support, in which exothermic surface reaction results in a temperature increase of the nickel pellistor, which in turn yields a change in the resistance of the nickel wire element.

When a nickel-plated silicon carbide monofilament is employed in the sensor, special care must be taken to protect the SiC, however, since it is readily etched by fluorine plasma. It therefore is essential that the nickel coating be moderately thick and have full coverage over the entire monofilament to protect the SiC core filament from fluorine. The thickness of the nickel coating therefore can be on the order of 2 microns or more in thickness. For a typical filament length used in an etch process monitor (EPM), the Ni-plated SiC monofilament exhibits a resistance in the order of ohms. This low resistance imposes a heavy burden on the associated measurement electronics. The plating of the SiC core filament also is tedious as one filament is plated at a time. In addition, in fluorine plasma cleaning operations, it is possible for pinholes to develop on the nickel layer over time, causing the SiC monofilament underneath to be exposed to fluorine plasma and the structure to fail.

In instances in which a downstream probe is employed for monitoring etching plasmas, then, the number of available materials of construction are limited, and constrain the ability of such monitoring devices to be widely implemented, despite their obvious utility. In current commercial practice, T-type thermocouples and nickel-leaded nickel oxide thermistors are employed, but T-type thermocouples generally contain copper, widely considered to be an unacceptable material in EPM applications, and nickel-leaded nickel oxide thermistors usually are packaged with encapsulation structure that must be removed for plasma monitoring applications.

In addition, existing setup of EPM systems requires a substantial amount of operator intervention. In particular, the choice of algorithm and trip point must be manually set after an operator analyzes signal traces that are collected from prior clean cycles.

It is apparent from the foregoing that the current monitoring approaches entail significant deficiencies and that improvements are necessary and desirable.

### SUMMARY OF THE INVENTION

The present invention relates generally to method and apparatus for determining the plasma conditions in an etching plasma processing facility, by monitoring presence and concentration of energetically active gas species in an effluent gas stream generated by the etching plasma processing facility at a location downstream of such etching plasma processing facility.

In one aspect, the present invention relates to a method for determining plasma conditions in an etching plasma processing facility, comprising the steps of:

providing at least one sensor element capable of exhibiting temperature change in presence of energetic gas species and correspondingly generating an output signal indicative of said temperature change;

contacting the sensor element with an effluent gas stream generated by such etching plasma processing facility at a location downstream of such etching plasma processing facility; and

determining the plasma conditions in such etching plasma processing facility, based on the output signal generated by the sensor element that is indicative of temperature change caused by the presence of energetic gas species in the effluent gas stream.

Such sensor element in one embodiment of the present invention may comprise at least two components that contain different metals or metal alloys and have a thermojunction therebetween. The thermojunction in such sensor element, upon contact with energetically active gas species in the effluent gas stream, generates a voltage differential correlative to temperature change caused by the presence of such energetically active gas species in the effluent gas stream, which can be used for determining the plasma conditions (e.g., plasma etching end point) in the etching plasma processing facility.

In another embodiment, the sensor element comprises a thermistor, a resistance temperature detector (RTD), or any other probe that is capable of exhibiting temperature change in the presence of energetic gas species and correspondingly generating an output signal indicative of said temperature change.

The energetic gas species that cause temperature change in the sensor element include, but are not limited to, fluorine, chlorine, iodine, bromine, oxygen, and derivatives and radicals thereof as generated by plasma conditions. Such energetic gas species are energy-carrying neutrals that have a relatively longer lifetime than the charged particles generated by the plasma conditions, and are capable of reaching a probe surface downstream of the etching plasma processing facility to impart energy on the probe surface via inelastic collisions and/or exothermic recombination.

In a further aspect, the present invention relates to a system for determining plasma conditions in an etching plasma processing facility, which comprises:

a gas sampling device for obtaining a gas sample from an effluent gas stream generated by the etching plasma processing facility at a location downstream of such etching plasma processing facility;

at least one sensor element operatively coupled with the gas sampling device for exposure to the gas sample, wherein such sensor element is capable of exhibiting temperature change in presence of energetic gas species and correspondingly generating an output signal indicative of the temperature change;

a monitoring assembly operatively coupled with the sensor element for monitoring the output signal generated by the sensor element that is indicative of temperature change caused by the presence of energetic gas species in such gas stream and determining the plasma conditions in the etching plasma processing facility based on the output signal.

As used herein, the term “fluoro species” or “fluorine” is intended to be broadly construed to encompass all fluorine-containing materials, including without limitation, gaseous fluorine compounds, fluorine per se in atomic and diatomic (F₂) forms, fluorine ions, and fluorine-containing ionic species, which are energetically activated under plasma conditions. The fluoro species may include activated fluorine-containing species, such as NF₃, SiF₄, C₂F₆, HF, F₂, COF₂, ClF₃, IF₃, etc. in ionized or plasma forms.

As used herein, the term “chlorine species” or “chlorine” is intended to be broadly construed to encompass all chlorine-containing materials, including without limitation, gaseous chlorine compounds, chlorine per se in atomic and diatomic (Cl₂) forms, chlorine ions, and chlorine-containing ionic species, which are energetically activated under plasma conditions. The chlorine species may include activated chlorine-containing species, such as NCl₃, SiCl₄, C₂Cl₆, HCl, Cl₂, COCl₂, ClF₃, ICl₃, etc. in ionized or plasma forms.

As used herein, the term “bromine species” or “bromine” is intended to be broadly construed to encompass all bromine-containing materials, including without limitation, gaseous bromine compounds, bromine per se in atomic and diatomic (Br₂) forms, bromine ions, and bromine-containing ionic species, which are energetically activated under plasma conditions.

As used herein, the term “iodine species” or “iodine” is intended to be broadly construed to encompass all iodine-containing materials, including without limitation, gaseous iodine compounds, iodine per se in atomic and diatomic (I₂) forms, iodine ions, and iodine-containing ionic species, which are energetically activated under plasma conditions.

As used herein, the term “oxygen species or “oxygen” is intended to be broadly construed to encompass all oxygen-containing materials, including without limitation, gaseous oxygen compounds, oxygen per se in atomic, diatomic (O₂), or triatomic (O₃) forms, oxygen ions, and oxygen-containing ionic species, which are energetically activated under plasma conditions. The oxygen species may include activated oxygen-containing species, such as H₂O, NO, NO₂, N₂O, etc. in ionized or plasma forms.

As used herein, herein, the term “metal or metal alloys” is intended to be broadly construed to encompass all metals or alloys of metals in their elemental form as well as conductive metal compounds such as metal silicides and/or metal nitrides.

In yet another aspect, the invention relates to a gas sensor, comprising:
a thermal isolation structure;
a catalytic material;
a heater; and
a temperature sensor;
   wherein:
the temperature sensor comprises at least one of a thermopile, a thermistor, and a thermoelectric element;
the catalytic material is catalytically interactive with a gas to effect reaction of the gas producing a heat effect;
the temperature sensor is adapted to sense the heat effect and produce a correlative output indicative of presence and/or concentration of the gas contacting the catalytic material; and
the thermal isolation structure is arranged to at least partially restrict heating of the catalytic material by the heater.

A further aspect of the invention relates to a chemical process assembly including a chamber adapted for flow of a process material therethrough, and a gas sensor as described hereinabove, adapted to sense said gas when present in the process material.

A still further aspect of the invention relates to a sensor including a silicon carbide filament that is electroplated with nickel film, said filament being oriented vertically and positioned in contact for gas sensing.

The invention in another aspect relates to a sensor adapted to sense a gas in a stream of effluent, said sensor including a temperature sensing element and a gas interaction element with which the gas reacts to product a thermal response detectible by the temperature sensing element, wherein the sensor is heated by joule heating by a heater, and is adapted for operation in accordance with the relationship

ΔW+{h(k, v)×ΔT_{effluent}+Tₑₗₑₘₑₙₜ×Δ[h(k, v)]}+ΔH·r=0

where ΔW is the necessary change in joule heating to maintain the sensing element at a set temperature Tₑₗₑₘₑₙₜ; h is the heat convection coefficient and is a function of effluent thermal conductivity k, and kinematic viscosity v; T_{effluent} is the effective effluent temperature; ΔH is the enthalpy of reaction that occurs on the sensing element surface, and r is the reaction rate.

An additional aspect of the invention relates to a method of sensing a gas in a stream of effluent containing or susceptible of containing the gas, comprising use of the gas sensor of the invention as described hereinabove.

Other aspects, features and embodiments of the invention will be more fully apparent from the ensuing disclosure and appended claims.

### BRIEF DESCRIPTION OF THE DRAWINGS

FIG. 1 shows a wishbone-shaped sensor element containing a copper filament and a constantan filament joined together at first ends thereof, according to one embodiment of the present invention.

FIG. 2 shows a Teflon®-coated sensor element, according to one embodiment of the present invention.

FIG. 3 shows the output signals of a sensor element in exposure to NF₃ plasma containing activated fluoro species, in side-by-side comparison with the fluorine partial pressure as measured by a residue gas analyzer (RGA).

FIG. 4 shows the response signals of a sensor element as a function of NF₃ composition under different pressures and gas flow rates, according to one embodiment of the present invention.

FIG. 5 illustratively depicts the cross-sectional view of a silicon substrate having a first sacrificial mold layer and a layer of barrier material deposited thereon.

FIG. 6 illustratively depicts the cross-sectional view of the structures of FIG. 1, except that the layer of barrier material is planarized to be coplanar with the first sacrificial mold layer.

FIG. 6A shows the top view of the structure of FIG. 6.

FIG. 7 illustratively depicts the cross-section view of the structures of FIG. 6, further having a second sacrificial mold layer formed thereon.

FIG. 8 illustratively depicts a cross-sectional view of the structure of FIG. 7, further having a layer of contact-forming material deposited thereon.

FIG. 9 illustratively depicts the cross-sectional view of the structure of FIG. 8, except that the layer of contact-forming material is planarized to be coplanar with the second sacrificial mold layer.

FIG. 9A shows a top view of the structures of FIG. 5.

FIG. 10 illustratively depicts the cross-sectional view of the structure of FIG. 9, further having a third sacrificial mold layer formed thereon.

FIG. 11 illustratively depicts the cross-sectional view of the structure of FIG. 10, further having a layer of support material deposited thereon.

FIG. 12 illustratively depicts the cross-sectional view of the structure of FIG. 11, except that the layer of support material is planarized to be coplanar with the third sacrificial mold layer.

FIG. 12A shows the top view of the structure of FIG. 12.

FIG. 13 illustratively depicts the cross-sectional view of the structure of FIG. 12, except that the third sacrificial mold layer is selectively removed and a layer of a sensor material is deposited thereon.

FIG. 13A shows the top view of the structure of FIG. 14.

FIG. 14 illustratively depicts the cross-sectional view of the structure of FIG. 13, except that the first and the second sacrificial molding layers are selectively removed, forming a free-standing gas sensing element and a contact/barrier element according to one embodiment of the present invention.

FIG. 14A shows the top view of the structure of FIG. 14.

FIG. 15 is a perspective view of an illustrative gas sensor assembly, comprising a free-standing gas sensing element supported by a contact/barrier element, according to one embodiment of the present invention.

FIG. 16 is a perspective view of a sensor assembly according to another embodiment of the invention.

FIG. 17 is a perspective view of a sensor according to a further embodiment of the invention.

FIG. 18 is a perspective view of a sensor according to a still further embodiment of the invention.

FIG. 19 is a top plan view of the sensor of FIG. 18.

FIG. 20 is a schematic representation of a process system in which a sensor according to one embodiment of the invention is mounted.

FIG. 21 is a micrograph, at 500 times magnification, of a sensor filament in which electroplated nickel has been removed to form a channel.

FIG. 22 is a graph of change in electrical resistance, as a function of time, for a comparison test of iron wire and nickel coated alumina (curve A) and a horizontally mounted straight nickel/coated SiC carbon fiber (XENA) (curve B).

FIG. 23 is a graph of resistance, in ohms, as a function of time, in minutes, showing the response of a Teflon-coated nickel plated SiC filament (curve A), a discontinuous nickel plated silicon carbide filament (curve D), a nickel plated SiC filament plated at a current of 0.125 milliamps for 5 hours (curve B), a nickel plated SiC filament plated at 0.25 milliamps for 5 hours (curve E) and the plasma on/off cycle (curve C).

FIG. 24 is a graph of thermocouple voltage as a function of time, for a test in which three thermocouples were examined under exposure to nitrogen trifluoride, including a bare wire T-type filament (curve A), a sheathed T-type filament (curve B) and a sheathed K-type filament (curve C).

### DETAILED DESCRIPTION OF THE INVENTION, AND PREFERRED EMBODIMENTS THEREOF

Thermal probes have been employed for studying the integral energy flux from plasma towards a location inside the plasma processing facility, such as the wafer substrate or the plasma reaction chamber wall. The integral energy flux experienced by such in situ thermal probes is the sum of energy fluxes carried by charged particles, neutrals, and photons present in the plasma as they impinge on the probe surface.

In contrast, the present invention employs downstream thermal probes, instead of in situ energy probes, for monitoring energy flux from an effluent gas stream generated by the plasma processing facility at a downstream location away from the plasma conditions.

At such downstream location, only energy fluxes carried by energetic neutrals, such as fluorine, chlorine, iodine, bromine, oxygen, and derivatives and radicals thereof, which are characterized by longer lifetime than charged particles and photons, may reach the surface of such downstream thermal probes. Because the intensity of the energy fluxes carried by such energetic neutrals correlates with the plasma conditions quantitatively, it can be advantageous used for downstream determination of the plasma conditions in the etching plasma processing facility.

Therefore, in one embodiment of the present invention, a sensor element, which is capable of exhibiting temperature change in the presence of the above-described energetic neutral species and correspondingly generating an output signal indicative of said temperature change, is exposed to an effluent gas stream generated by the etching plasma processing facility at a location downstream of the etching plasma processing facility, for monitoring the energy fluxes carried by such energetic neutrals in the effluent gas stream. For example, such sensor element may be operatively coupled with a gas sampling device, either coupled to a downstream fluid flow path or constituting a part of such fluid flow path, for obtaining a gas sample from the effluent gas stream at such downstream location and exposing the sensor element to the gas sample.

The energetic neutrals, if present in the effluent gas stream, therefore reach the surface of such downstream sensor element to impart energy on the sensor surface via inelastic collisions and/or release reaction energy by exothermic recombination thereof on the sensor surface, causing detectable temperature change on the surface of such sensor element. Such temperature change is correlative to the presence and concentration of the energetic neutrals in the effluent gas stream, and is therefore useful for inferring the plasma conditions in the etching plasma processing facility.

Preferably, such sensor element comprises two different metal components joined together with a heterojunction therebetween, which exhibits detectable change in the voltage differential between the two components of the sensor element in the presence of energetic gas species. Such change in the voltage differential quantitatively correlates with the concentration of the energetic gas species in the effluent gas stream, and can be monitored by a monitoring device for inferring the plasma conditions in said etching plasma processing facility.

The specific structure, composition, and surface condition of such sensor element are not critical for the practice of the present invention.

Preferably, when the effluent gas stream is susceptible to presence of energetic fluoro species or other halogen species, such sensor element comprises materials that are resistant to corrosion or attack by the fluoro species or other halogen species, or is otherwise protected from such corrosion or attack, e.g., by a fluoro- or halogen-resistant coating. For instance, the two components of such sensor element may be formed by metal filaments containing metals or metal alloys such as nickel, aluminum, and copper, and alloys thereof, and such metal filaments may have an average diameter of from about 0.1 micron to about 1000 microns.

A particular preferred type of sensor element for practicing the present invention is a sensor element that comprises a first component made of copper and a second component made of a copper-nickel alloy such as constantan. Both copper and nickel are fluoro-resistant, and such sensor element can therefore be used for detecting energetic fluoro species.

Further, the sensor element may comprise a fluoro-resistant coating that protects the two metal components of the sensor element from corrosion and attack by the fluoro species. For example, such sensor element may have a coating formed of polytetrafluoroethylene, alumina, Group II metal fluorides (such as CaF₂ and MgF₂), and perfluorinated polymers (such as polyimide materials commercialized by DuPont under the trademark Vespel®). Still further, such fluoro-resistant coating functions to insulate the metal components of the sensor element and thereby avoid inadvertent contact of the metal components with external conductors or conducting materials, which may interfere with the measurement of the voltage differential.

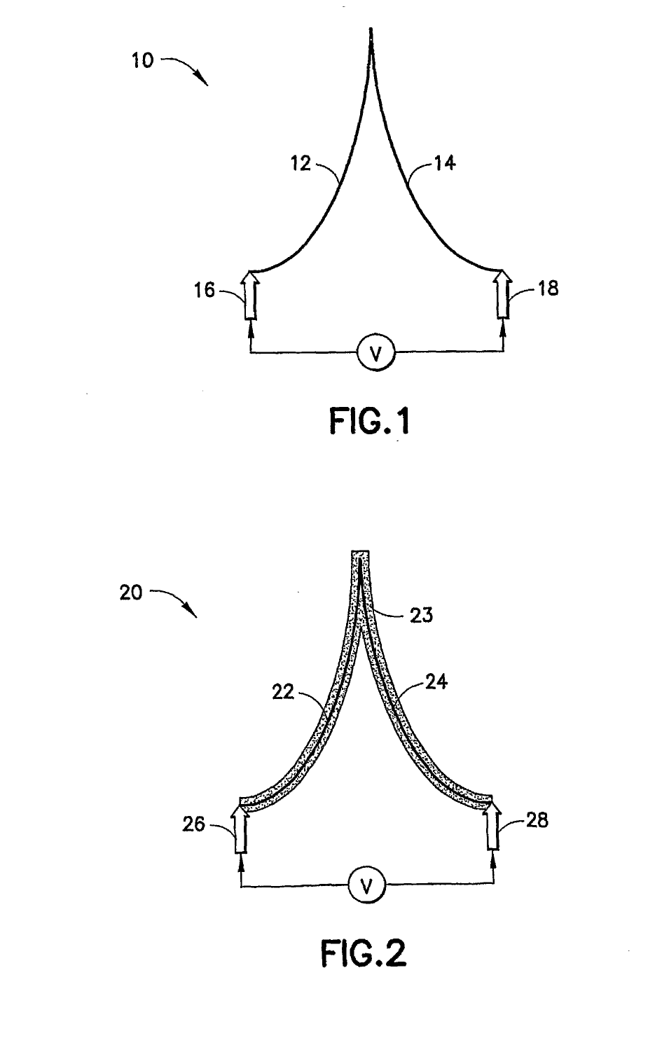

FIG. 1 shows an exemplary wishbone-shaped sensor element 10, which contains a first component 12 formed of a copper filament and a second component 14 formed of a constantan filament as joined at one ends thereof to form a heterothermojunction. The other ends of the first and second components 12 and 14 are fixed to or otherwise mounted onto two electrical contacts or terminals 16 and 18, and a monitoring and signaling device (not shown) as described hereinabove can be used to monitor the voltage differential between these two terminals 16 and 18 for determining presence and concentration of the fluoro species.

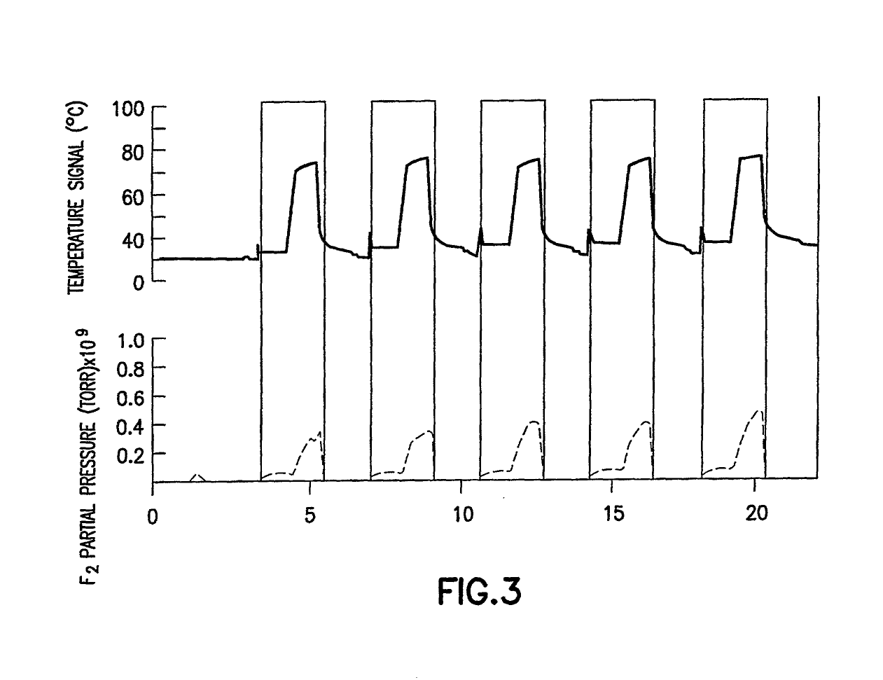

FIG. 2 shows another exemplary sensor element 20, which contains a first component 22 and a second component 24 formed of different metals or metal alloys. A fluoro-resistant coating 23 containing polytetrafluoroethylene insulates both components as well as protects such from attack by the corrosive fluoro species. The first and second components 22 and 24 are joined at one ends thereof to form a heterojunction and fixed to or otherwise mounted onto two electrical contacts or terminals 26 and 28, to which a monitoring and signaling device (not shown) can be electrically coupled for monitoring the voltage differential between these two terminals 26 and 28.

Measurement of the voltage differential between the two components of the sensor element can be readily achieved by a voltmeter with a simple signal amplification element, or any other suitable instruments or apparatus. Preferably, cold thermojunction compensation (CJC) techniques are used to compensate for the impact of any additional heterojunction formed between the sensor element and the measuring instrument and to ensure accurate measurement of the voltage differential.

Signal measurement for the above-described sensor element is simple and straightforward, and a person ordinarily skilled in the art can readily determine the components and configuration of the monitoring and signaling device, without undue experimentation. More importantly, the signal measurement for such sensor element of the present invention is passive, i.e., no external energy is required for the operation of such sensors.

Alternatively, the sensor element of the present invention may comprise any other thermal probes, including but not limited to thermistors and resistance temperature detectors (RTDs). The RTD may operate in measurement mode where its resistance is read without modification. Alternatively, the RTD may operate in constant resistance or constant current control mode, where the resistance of such RTD or the current that passes through such RTD is manipulated to maintain at a prescribed, constant value, for example, by varying the electrical power delivered to it. In the latter case, the manipulated power provides an indirect temperature measurement.

Although the above-description is primarily directed to detection of energetic fluoro species, the present invention can be readily applied to other energetic gas species, including but not limited to chlorine, iodine, bromine, oxygen, and derivatives and radicals thereof.

The gas-sensing system of the present invention may include a single gas sensor as described hereinabove, or a plurality of such gas sensors, wherein the multiple gas sensor elements provide redundancy or back-up sensing capability, or in which different ones of the multiple sensor elements are arranged for sensing of different energetic gas species in the stream or gas volume being monitored, or in which different ones of the sensor elements in the array are operated in different modes, or in interrelated modes, such as for production of respective signals that are algorithmically manipulated, e.g., subtractively, to generate a net indicating signal, or alternatively, additively to produce a composite indicating signal, or in any other suitable manner in which the multiplicity of sensor elements is efficaciously employed to monitor the energetic gas species in the stream or fluid volume of interest, for generation of correlative signal(s) for monitoring or control purposes.

In connection with the use of arrays of gas-sensing elements, advanced data processing techniques can be used to enhance the output of the sensor system. Examples of such techniques include, but are not limited to, the use of compensating signals, the use of time-varying signals, heater currents, lock-in amplifying techniques, signal averaging, signal time derivatives, and impedance spectroscopy techniques. In addition, advanced techniques that fall into the category of chemometrics may also be applied. These techniques include least squares fitting, inverse least squares, principal component regression, and partial least square data analysis methods.

The gas-sensing element(s) of the invention may therefore be coupled in a suitable manner, within the skill of the art, to transducers, computational modules, or other signal processing units, to provide an output indicative of the present or change in amount of one or more energetic gas species in the fluid environment being monitored.

### EXAMPLE

A test was conducted to determine the response of a sensor element as illustrated by FIG. 1 when exposed to NF₃ plasma that contains energetic fluoro species.

The plasma source was an ASTRON AX 7650 Atomic Fluorine Generator by ASTeX operating at 400 kHz and 6 kW. Mass flow controllers were used to control process gas (Ar and NF₃) flows. A specimen port immediately at the plasma source outlet allowed insertion of test specimens such as silicon wafers. The transfer tube was made of 6061 T6 Aluminum, and there were multiple ports along the transport tube for thermal probe installation. A capacitance manometer was used to provide pressure readings, and a throttle valve was used to control the transfer tube pressure.

With respect to the sensor element, a copper filament and a constantan filament of about 0.005 inch in diameter (as purchased from Omega Engineering, Inc. at Stamford, Conn.) were spot-welded together at first ends thereof to form a sensor element with a heterojunction at the welding point. Such sensor element was then attached to a sensor element vacuum feedthrough with copper and constantan connectors (as purchased from CeramTec North America Corp. at Laurens, S.C.), which were in turn coupled to a signal converter for automatic conversion of the voltage differential reading into a temperature reading.

Five deposition/cleaning cycles were simulated. Specifically, the deposition cycles were simulated by providing nitrogen purge at 70 mTorr, and the cleaning cycles were simulated by providing active plasma with argon at 5 Torr and about 1 standard liter per minute (slm). At the mid-point of each cleaning cycle, 500 sccm of NF₃ was gradually added over a 15-second interval to simulate a fluorine rising endpoint for the NF₃ plasma cleaning.

An RGA300 Residue Gas Analyzer by Stanford Research Systems was used to track the temporal evolution of chemical species, specifically the actual fluorine concentration in the test manifold, which scanned a full 100 atomic mass unit spectrum every 10 seconds. Mass 38 was plotted as the indicator for fluorine (F₂) concentration in the test manifold.

FIG. 3 shows the temperature readings of the sensor element through such five simulated deposition/cleaning cycles, in comparison with the fluorine concentration readings of the RGA. Clearly, the temperature readings of the sensor element-based sensor of the present invention correlate well with the fluorine concentration readings of the RGA.

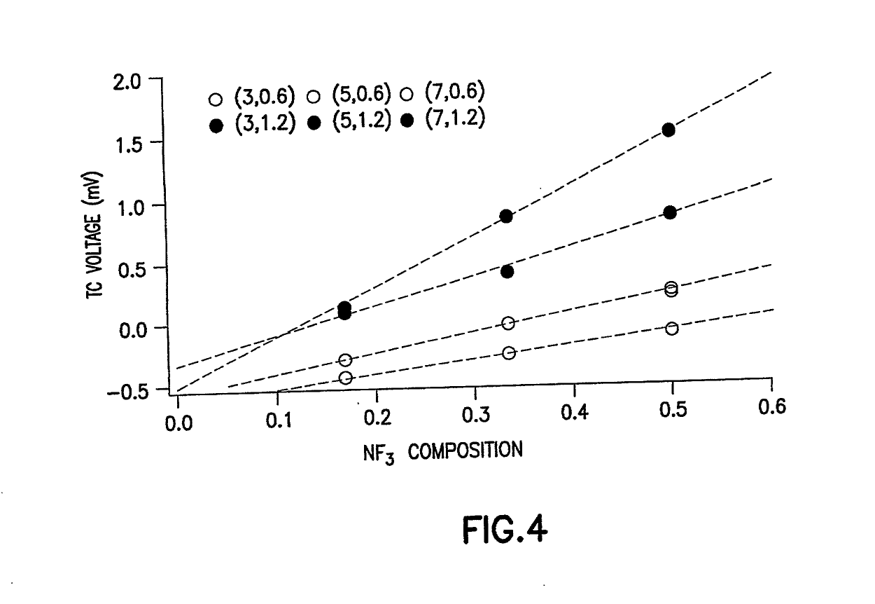

Further, a 2×3 matrix design of experiment was executed to study the sensor response characteristics. Specifically, the transfer tube pressure was varied between 3, 5, and 7 torr, while the total gas flow was varied between 0.6 and 1.2 SLM. At each combination of transfer tube pressure and total gas flow, NF₃ composition was varied between ⅙, 2/6, and 3/6, by volume of the total gas feed. The signal dependence on NF₃ composition and corresponding test conditions are shown on FIG. 4 for the entire design of experiment matrix. There is a linear correlation between the sensor response and NF₃ composition, from which quantitative parameters can be derived to reproduce the response characteristics.

The disclosures of U.S. Patent Application Publication No. 20040074285 published Apr. 22, 2004 for “APPARATUS AND PROCESS FOR SENSING FLUORO SPECIES IN SEMICONDUCTOR PROCESSING SYSTEMS” and U.S. Pat. No. 6,265,222 issued Jul. 24, 2001 for “MICRO-MACHINED THIN FILM HYDROGEN GAS SENSOR, AND METHOD OF MAKING AND USING THE SAME” are incorporated herein by reference in their entirety for all purposes.

The invention contemplates a gas sensor, comprising:
a thermal isolation structure;
a catalytic material;
a heater; and
a temperature sensor;
   wherein:
the temperature sensor comprises at least one of a thermopile, a thermistor, and a thermoelectric element;
the catalytic material is catalytically interactive with a gas to effect reaction of the gas producing a heat effect;
the temperature sensor is adapted to sense the heat effect and produce a correlative output indicative of presence and/or concentration of the gas contacting the catalytic material; and
the thermal isolation structure is arranged to at least partially restrict heating of the catalytic material by the heater.

The gas sensor, in one embodiment thereof, comprises catalytic material including nickel. The gas sensor may be configured as a microhotplate or as a pellistor, and the catalytic material may be present as a surface coating on the microhotplate.

The gas sensor may be fabricated in any suitable form. The substrate can be silicon carbide or other appropriate material. The heater can comprise an electrically resistive material, and the catalytic material can be provided in a form that is not electrically connected. The electrically resistive material can constitute polysilicon.

The heater is adapted to maintain a constant temperature in a reference portion of the temperature sensor, so that variation of heating by the heater is indicative of catalytic interaction with the gas with the catalytic material.

Alternatively, the heater can be adapted to operate at a fixed electrical condition selected from among voltage, current and power, so that variation in temperature is indicative of catalytic interaction of the gas with the catalytic material.

The heater can include a thermopile, e.g., including a polysilicon/nickel junction.

In the gas sensor, the catalytic material can include a nickel layer on a silicon carbide substrate. In a particularly preferred embodiment, the gas sensor includes an electroplated nickel silicon carbide filament.

The gas sensor can be arranged to maintain the electrical resistance of the electroplated nickel silicon carbide filament constant, wherein a change in the electrical resistance is indicative of the presence and/or concentration of the gas contacting the catalytic material.

The invention contemplates a chemical process assembly including a chamber adapted for flow of a process material therethrough, and a gas sensor as described above, adapted to sense the gas when present in the process material. The gas sensor in such assembly can be fabricated with a ⅜ inch plug or a ⅛ inch plug enabling the sensor to be affixed to the chamber.

The gas sensor can include a vertically oriented metal coated filament as the catalyst material and the temperature sensor. A sensor can thus be provided, including a silicon filament that is electroplated with nickel film, such filament being oriented vertically and positioned in contact for gas sensing. The sensor can also include press fit contacts for securing the filament in position. Channels may be present in the filament, for use in coupling the sensor to a substrate.

The sensor may be arranged to determine end point of a chamber cleaning operation by change of electrical properties of the nickel coating. The sensor may be operated so that presence of gas is determined by change of electrical properties of the filament. The electrical connections are separate. In general, the electrical connection can be of any suitable type, including at least one of mechanical connection, electroplating connection and electroplating connection.

The sensor in another embodiment includes a micromachined Ni pellistor on an alumina support.

The invention in another embodiment provides a sensor adapted to sense a gas in a stream of effluent, such sensor including a temperature sensing element and a gas interaction element with which the gas reacts to product a thermal response detectible by the temperature sensing element, wherein the sensor is heated by joule heating by a heater, and is adapted for operation in accordance with the relationship

ΔW+{h(k, v)×ΔT_{effluent}+Tₑₗₑₘₑₙₜ×Δ[h(k, v)]}+ΔH·r=0

where ΔW is the necessary change in joule heating to maintain the sensing element at a set temperature Tₑₗₑₘₑₙₜ; h is the heat convection coefficient and is a function of effluent thermal conductivity k, and kinematic viscosity v; T_{effluent} is the effective effluent temperature; ΔH is the enthalpy of reaction that occurs on the sensing element surface, and r is the reaction rate.

The invention in another embodiment provides a method of sensing a gas in a stream of effluent containing or susceptible of containing the gas, comprising use of the gas sensor as described hereinabove.

While the invention is described herein with specific reference to applications in semiconductor process control, it is to be appreciated that the utility of the invention is not thus limited, but rather extends to a wide variety of other uses and applications, including, without limitation, deployment in life safety systems, room or ambient environment monitoring operations, and other industrial as well as consumer market gas sensing applications.

The present invention in one embodiment thereof provides a microelectromechanical system (MEMS)-based gas sensing capability for determining the endpoints of semiconductor chamber clean processes.

Conventional MEMS designs (for other, more benign gas environments) require deposition of the sensing metal layers on a silicon-based device structure, and subsequent bonding and packaging of the device into a chip carrier. In one embodiment, this fabrication approach entails a multi-step process, involving a corresponding multicomponent product sensor assembly in which each component is subject to chemical attack by the heavily fluorinated gases. While it may be possible to protect each of the respective components by developing a suitable encapsulation structure, such expedient adds further fabrication complexity, manufacturing time and cost to the product gas sensor device.

These obstacles are overcome in a manner enabling the use of a MEMS-based sensor device that is easily and inexpensively fabricated, and readily implemented for monitoring fluorinated gases in semiconductor chamber clean processes in an efficient, durable and reliable manner in the harsh chemical environment of such processes.

The fluorinated gas sensor device of the present invention, in one embodiment described more fully hereinafter, has multiple advantageous features that distinguish it as a breakthrough in the art.

One such feature is the use in the device of high performance fluorine-reactive metal sensing elements, such as nickel or nickel alloy, which are characterized by high electrical resistance, low thermal mass, small density, and high temperature coefficient of resistivity that are particularly suitable for resistance-based gas sensing.

The second feature relates to use of the metal elements both as a sensing material and as a heat source (e.g., by resistive, conductive, or other heating thereof) for the gas sensing operation, as for example where it is desired to vary the sensing temperature from ambient conditions, or to match the temperature of a semiconductor chamber whose effluent includes the target gas species to be monitored.

The third feature relates to the use of silicon carbide (SiC) in conjunction with SiO₂/polysilicon sacrificial materials for forming free-standing silicon carbide support structures, which eliminates formation of heat sinks in connection with the metal sensing element and therefore minimizes heat loss.

The fourth feature relates to the use of micro-molding techniques for fabricating planarized structural layers, which allows automated and scale-up production of gas sensing devices and provides high precision over product quality control.

The foregoing features are independent of each other and can be incorporated either separately or jointly. The substrate and/or support material may alternatively be fabricated from an etch-resistant polymeric material.

The fluoro or halogen species sensor device may include a single sensing element in any of the numerous suitable forms described hereinafter.

Alternatively, the fluoro or halogen species sensor device may comprise a plurality of such sensing elements, wherein the multiple elements provide redundancy or back-up sensing capability, or in which different ones of the multiple sensing elements are arranged for sensing of different fluoro or halogen species in the stream or gas volume being monitored, or in which different ones of the sensing elements in the array are operated in different modes, or in interrelated modes, such as for production of respective signals that are algorithmically manipulated, e.g., subtractively, to generate a net indicating signal, or alternatively, additively to produce a composite indicating signal, or in any other suitable manner in which the multiplicity of sensor elements is efficaciously employed to monitor the flow of species in the stream or fluid volume of interest, for generation of correlative signal(s) for monitoring or control purposes.

As is well known, fluorine reacts with most metals, and gives rise to compounds that have a high, and sometimes, mixed oxidation state (Inorganic Solid Fluorides, Chemistry and Physics. Academic Press, 1985, Ed P. Hagenmuller). Many of the transition metals and noble metals (including, for example, but not limited to, Ti, V, Cr, Mn, Nb, Mo, Ru, Pd, Ag, Ir, Ni, Al, Cu and Pt) readily form various non-volatile fluorinated compounds in contact with fluorine gas components. The gas sensing device and method disclosed herein can use free-standing forms of these metals to detect the presence of fluorinated species in the gas being monitored.

The choice of a specific sensing material of construction may be readily determined for a given end-use application of the invention, by simple experiment involving exposure of candidate gas sensing element materials of construction to the fluoro or halogen species-containing environment, and determining the suitability, e.g., corrosion-resistance or etch-resistance, of the candidate materials in such exposure.

Nickel or nickel alloy (such as Monel) is particular preferred as a fluoro or halogen sensing material, due to its high fluorine-resistivity, high electrical resistance, low thermal mass, small density, and high temperature coefficient of resistivity. The ratio of signal strength/response time in resistance-based gas sensing operation is significantly influenced by the material properties of the sensor material, and nickel or nickel alloy-based sensor elements have been discovered to provide the maximum signal strength/response time ratio among metal sensor elements, when the sensor form/dimension and the instrumentational factors provided are the same.

Detection of the fluoro or halogen species of interest may be achieved in any suitable manner, e.g., by means of a change in resistance of the free-standing metal material as it reacts with fluorine-containing species.

The metal sensing element in the fluorine detectors may be provided in any of numerous suitable forms, and may have tailored morphology, such as roughened surfaces or induced nanoporosity. The resistance and behavior of the metal element can be engineered by altering the geometry of the structure. For example, the geometry of a suspended metal thin film can be engineered by choosing the width, length and thickness of the film over the suspended area appropriately. A suspended metal filament can be thinned after fabrication thereof, in any of a variety of ways, e.g., mechanically, chemically, electrochemically, optically or thermally, in order to increase the absolute resistance, as well as to increase the surface area-to-volume ratio of the metal, to thereby increase the sensitivity or improve the signal-to-noise ratio. Further, the material's physical properties can be engineered. For example, the composition can be modified either by alloying or doping, and the microstructure can be modified, e.g., by change in grain size, level of crystallinity, porosity (e.g., nanoporosity), surface area-to-volume ratio, etc.

It will therefore be apparent that the metal sensing element may be variously configured and modified as desired with respect to its form, conformation, physical properties, chemical properties and morphological character, within the skill of the art and without undue experimentation.

The reaction of the fluorine compound with the metal sensing element may be temperature-sensitive, and heating of the metal can be achieved by passing current through it. In this way, the metal sensing elements may be utilized in the gas sensing operation concurrently as heating structures.

In order to enhance the sensitivity and signal-to-noise ratio of the gas sensor of the invention, a fluoro- or halogen-sensitive metal thin film is deposited on a free-standing silicon carbide support structure that is characterized by high electrical resistance and low thermal mass. The high electrical resistance of such SiC support structure further enhances the sensitivity and signal strength of the sensor; the low thermal mass of SiC minimizes potential heat loss from the support structure; and such SiC support structure, being free-standing itself, effectively isolates the metal sensing film from the substrate and enhance the signal-to-noise ratio.

Such free-standing silicon carbide support structure may be fabricated by: (1) providing on a substrate a sacrificial mold having recesses therein that define a predetermined support structure, (2) depositing a SiC film into the recesses of such sacrificial mold, and (3) selectively removing the sacrificial mold, to form a free-standing SiC support structure that is separated from the substrate by air gaps or empty spaces originally occupied by such sacrificial mold.

The sacrificial mold may be formed by depositing a layer of sacrificial materials and then patterning such layer to form the necessary recesses that define the predetermined support structure. Any suitable materials that are selectively removable in connection with the support structure may be used as the sacrificial materials for the practice of the present invention. For example, silicon dioxide is selectively removable by fluorine-containing compounds such as HF, in connection with the silicon carbide support structure that is resistant to the fluorine-containing compounds.

After formation of the support structure, a layer of a fluoro- or halogen-sensing material, preferably a fluoro- or halogen-reactive metal or metal alloy, may be coated over such support structure, to form a free-standing gas sensing assembly that is responsive to the presence of fluoro or halogen species.

One or more spaced-apart upstanding contacts may be provided to support such free-standing gas sensing assembly, preferably only at its peripherals. More preferably, such spaced-apart upstanding contacts comprise materials of high electrical resistance, low thermal mass, and high resistance to corrosive fluorine-containing compounds. Silicon carbide is particularly preferred for forming such contacts.

When the free-standing gas sensing assembly is formed over a substrate (such as silicon substrate) that is susceptible to attacks by the corrosive fluorine-containing compounds, a barrier layer that is resistant to such compounds is preferably provided to cover and protect the substrate. Such barrier layer may comprise any fluoro or halogen resistant materials, including but not limited to polyimide and silicon carbide, among which silicon carbide is preferred.

In one preferred embodiment, a gas sensor assembly comprises a free-standing gas sensing element, one or more spaced-apart upstanding contacts, and a barrier layer, while the spaced-apart contacts are fabricated on the barrier layer, forming an integral contact/barrier element for supporting the free-standing gas sensing element and for covering and protecting the substrate member thereunder.

Referring now to the drawings, FIGS. 5-14A are schematic illustrations depicting the process flow in the manufacture of a gas sensing assembly that comprises a free-standing gas sensing element and a contact/barrier element as described hereinabove, according to one embodiment of the present invention.

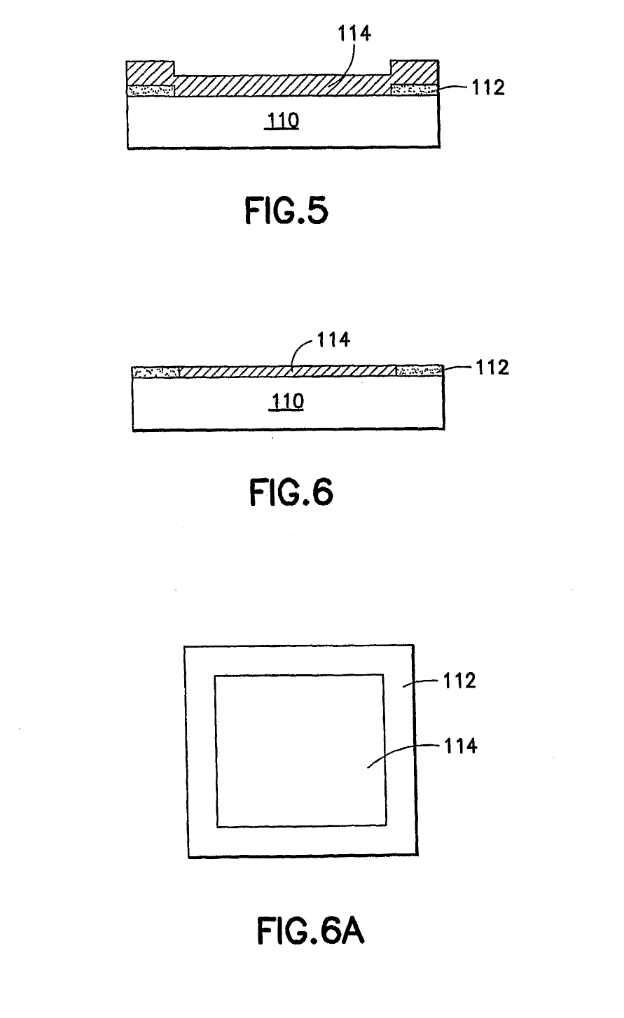

As shown in FIG. 5, a substrate member 110 is provided, upon which a layer of a first sacrificial molding material (preferably silicon dioxide) 112 is deposited and patterned, to form a barrier recess therein. A layer of a barrier material (preferably silicon carbide) 114 is deposited in such barrier recess on substrate member 10 as well as on the first sacrificial molding material 112, and then planarized to expose the first sacrificial molding material 112, as shown in FIG. 6.

The planarization step improves the planarity of the structural layers, and assists thereby in achieving good control of the geometry of the subsequently formed structural layers. The planarization step is optional, and may be omitted in instances where good self-leveling behavior is demonstrated by the barrier material, and it is possible to apply the barrier material into the barrier recesses so as to be near-level with the adjacent surface of the first sacrificial molding material surrounding such recesses.

FIG. 6A shows the illustrative top view of the structures of FIG. 6, from which the first sacrificial molding material 112 is visible, with a square-shaped barrier recess filled with the barrier material 114 therein. Please note that the shape and conformation of the barrier recess can be readily modified by a person ordinarily skilled in the art, according to the specific end use and system requirements, and are therefore not limited by the illustrative example provided herein.

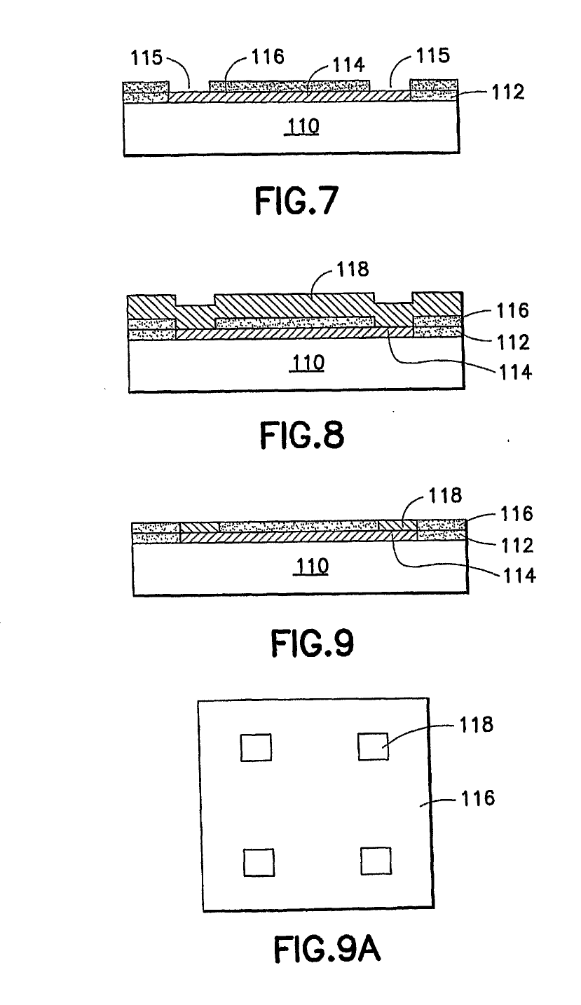

A layer of a second sacrificial molding material (preferably silicon dioxide) 16 is further deposited on the planarized barrier material 114 and the first sacrificial molding material 112, and patterned to provide contact recesses 115, which defines one or more spaced-apart contacts that are positioned over the planarized barrier material 114, as shown in FIG. 7.

A contact-forming material (preferably silicon carbide) 118 is then deposited into such contact recesses and planarized to expose the second sacrificial molding material 116, as shown in FIGS. 8-9. FIG. 9A provides the top view of the structures of FIG. 9, from which the second sacrificial molding material 116 is visible. Four spaced-apart square contact recesses are formed in the second sacrificial molding material 116 and are filed with the contact-forming material 118.

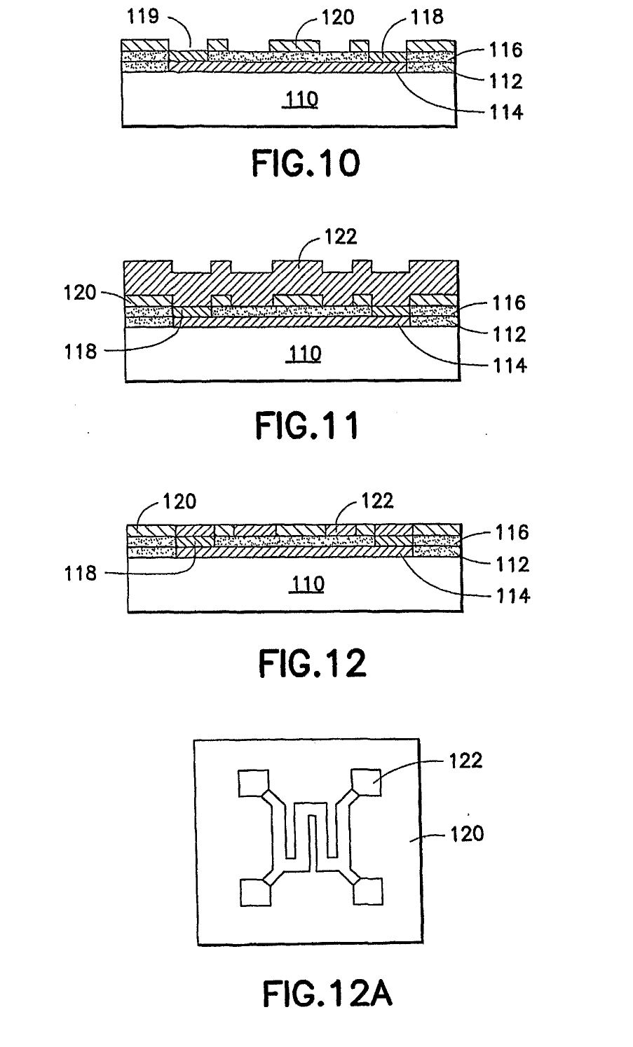

FIG. 10 shows deposition and patterning of a layer of a third sacrificial molding material (preferably polysilicon) 120, which contains structural recesses 119 that define a predetermined support structure. Specifically, such structural recesses 119 are positioned above both the contact-forming material 118 and the second sacrificial molding material 116, and the support structure so defined therefore bridges over the spaced-apart contacts and the second sacrificial molding material 116.

FIGS. 11-12 shows deposition of a layer of a support material (preferably silicon carbide) 122 in such structural recesses, and subsequent planarization thereof to expose third sacrificial molding material 120.

FIG. 12A shows the top view of the structures in FIG. 12, comprising a support structure 122 formed in the structure recesses in the third sacrificial molding material 120, while such support structure 122 bridges over the four spaced-apart contacts (not visible in FIG. 12A) and the second sacrificial molding material 116 (not visible in FIG. 12A).

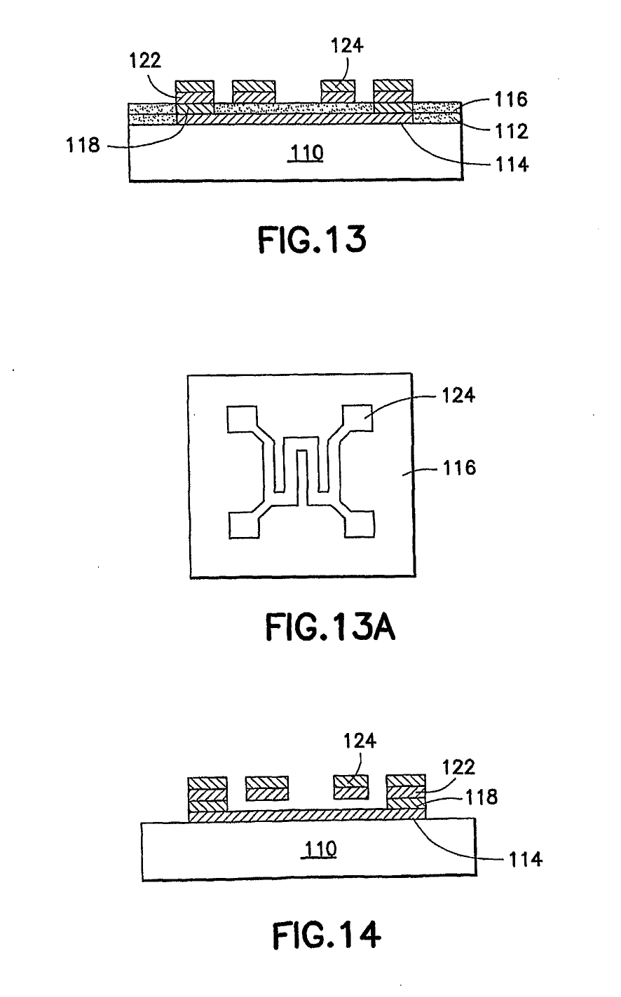

In FIG. 13, the third sacrificial molding material 120 is selective removed, thereby forming a protruding support structure formed of the support material 122 and exposing the second sacrificial molding material 116, and a layer of a fluorine-reactive metal or metal alloy (preferably containing nickel) 124 is deposited over such protruding support structure. FIG. 13A shows the top view of the structures of FIG. 13, from which the second sacrificial molding material 116 and the fluorine-reactive metal or metal alloy 124 are visible.

Finally, the first and the second sacrificial molding materials 112 and 116 are selectively removed, forming a free-standing gas sensing element comprising the support structure 122 and the fluorine-reactive metal layer 124 thereon, and a contact/barrier element comprising the spaced-apart contacts 118 and the barrier layer 114. The free-standing gas sensing element is supported by spaced-apart contacts 118 at its peripheral, while the central major portion of such gas sensing element is suspended and isolated. The barrier layer 114 supports the contacts 118 thereon and protects the underlying substrate member 110 from potential attacks by corrosive fluorine-containing compounds.

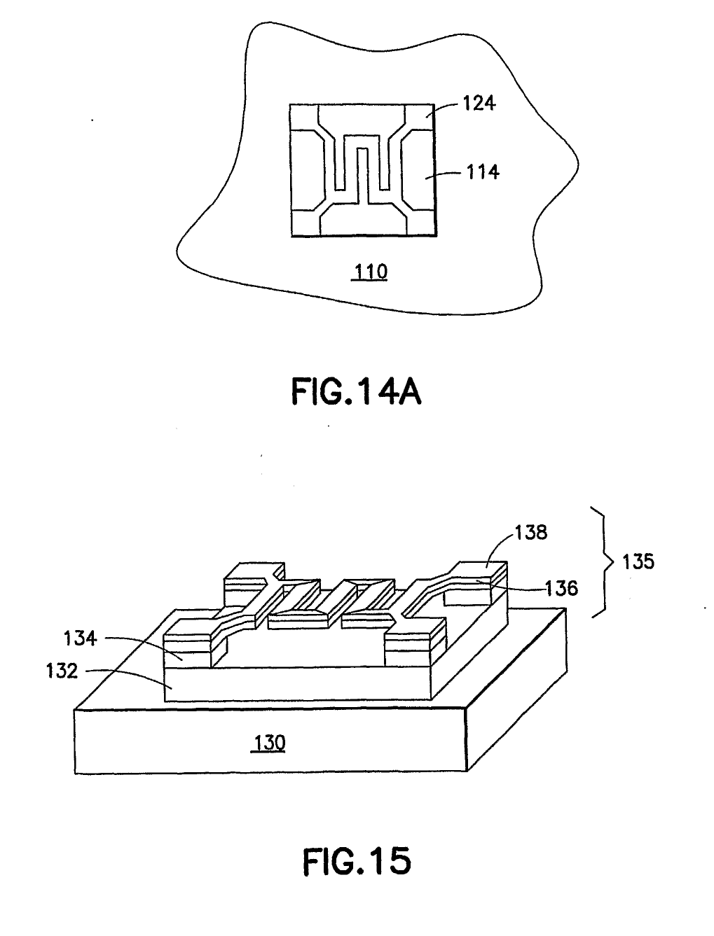

FIG. 14A shows the top view of the structures of FIG. 14, in which only the metal layer 124 of the free-standing gas sensing element and the barrier layer 114 of the contact/barrier element are visible.

FIG. 15 is a perspective view of a gas sensor assembly according to one embodiment, which comprises a free-standing gas-sensing element 135 containing a silicon carbide layer 136 having a nickel coating 138 thereon. Such gas-sensing element 135 is supported at its peripheral by spaced-apart upstanding contacts 134. A barrier layer 132 provides support to the spaced-apart contacts 134 as well as protects the underlying substrate 130 from the harsh chemical conditions imposed by the corrosive target gas species during the gas sensing operations.

The gas-sensing element 135 suspends over the barrier layer 132 as well as the substrate 130 thereunder, and only peripherally contacts the spaced-apart contacts 134 at very limited areas. Therefore, the majority surface area (preferably more than 80% surface area, and more preferably more than 95%) of the gas-sensing element 135 is suspended and isolated from the substrate 130 by air cavity. Further, by forming the spaced-apart contacts 134 with materials characterized by high electrical resistance and low thermal mass (e.g., silicon carbide), potential heat loss from the gas-sensing element 135 can be minimized. Further, the gas assembly of the present invention is formed of fluorine-resistant materials such as silicon carbide, and therefore is particularly robust and reliable in gaseous environment susceptible to presence of fluorine-containing compounds.

The free-standing gas sensing-element in the gas sensor assembly is preferably of a high surface to volume (S/V) character, to facilitate rapid response, and to amplify the response relative to the substantially lower change in the gas-indicating bulk property that would otherwise occur in a low S/V conformation of the same sensor material.

Thus, the critical dimension of the free-standing gas sensing element—the thickness dimension for foils or films, or the diameter for forms such as filaments, bars, or columns, etc.—desirably is less than 500 microns (μm), preferably less than 150 μm, more preferably less than 25 μm, still more preferably is less than 10 μm, and most preferably is in a range of from about 0.1 μm to about 5 μm, as a balance of response speed and ease of fabrication considerations.

Foils and films, in addition to having a low thickness, e.g., in a range of from about 0.1 μm to about 50 μm, desirably have small dimensional characteristics in the plane perpendicular to the thickness direction of the foil or film, again for reasons of responsivity. The lateral dimensions in such plane (x-y plane, where the z axis is the thickness direction) include a length (x-direction) and width (y-direction) that are advantageously less than about 10 cm, preferably being less than about 1 mm and more preferably less than about 100 μm, e.g., in a range of from about 20 μm to about 5 mm, as a balance of fabricational complexity and responsiveness. In general, suitable dimensions of sensor wires can be readily determined to provide correspondingly suitable signal-to-noise ratios for the intended applications.

In the context of the foregoing description, it is to be appreciated that the free-standing gas sensing element could be fabricated as a nano-scale element, albeit as a more costly gas sensor product than the typically millimeter/micrometer-scale elements discussed above.

In instances where multiple metal sensing element structures are provided, different ones of the multiple metal structures may be constructed and arranged for sensing of different fluorinated species in the fluid environment being monitored, and/or same fluorinated species at different temperatures, and different geometries and configurations of sensing elements may be employed for redundancy and/or ensuring accuracy, etc. Alternatively, or additionally, different ones of the multiple sensing elements may be operated in different operating modes, e.g., resistively, conductively, pulsed, a DC mode, an AC mode, etc.

In connection with the use of arrays of gas sensing elements, advanced data processing techniques can be used to enhance the output of the sensor system. Examples of such techniques include, but are not limited to, the use of compensating signals, the use of time-varying signals, heater currents, lock-in amplifying techniques, signal averaging, signal time derivatives, and impedance spectroscopy techniques. In addition, advanced techniques that fall into the category of chemometrics may also be applied. These techniques include least squares fitting, inverse least squares, principal component regression, and partial least square data analysis methods.

For example, on being contacted by fluorine compound(s) such as SiF₄, and/or other fluoro or halogen species, the voltage across the metal sensing element (as a component of an electrical circuit) may drop, indicative of an increase in resistance of the metal sensing element incident to its contact with a target fluoro or halogen species. Such voltage drop can be employed to generate a signal for process control purposes. The voltage drop can be employed to generate a signal that actuates an automatic control valve, to effect flow initiation, flow termination, or flow switching of a process stream in the semiconductor process system. The control signal alternatively may be employed to actuate a cycle timer, to initiate a new step in the process operation, or to signal that a maintenance event, such as change-out of a scrubber resin in an abatement process chamber, is necessary or desirable.

It will be appreciated that the change in properties of the metal sensing element can be exploited in any of a variety of ways, to effect the control of a process in relation to the sensing of the target gas (e.g., fluoro or halogen) species, within the skill of the art and without undue experimentation.

By way of further examples, the sensor assembly of the invention may be utilized in connection with a gas cabinet containing a supply of a fluoro or halogen species gas (such as a perfluoro species, e.g., a perfluorinated organometallic precursor for chemical vapor deposition operations), and the gas sensor assembly may be employed to determine the existence of a leak from the supply vessel or otherwise in the flow circuitry in the gas cabinet. The sensing of the fluoro or halogen species then may be utilized to actuate a source of bulk purge gas, to sweep out the interior volume of the gas cabinet and prevent the concentration of the fluoro or halogen species from reaching toxic or otherwise hazardous levels.

The sensor assembly may also be utilized in a monitoring unit for an ambient environment that is susceptible to the ingress or generation of fluoro or halogen species therein, or alternatively the sensor assembly could be a constituent part of a wearable gas monitoring unit that is arranged to actuate an alarm and/or a self-contained source of emergency breathing gas, for hazardous materials cleanup crews, firefighters in chemical complexes, workers in HF glass-etching operations, etc.

The gas sensor assembly is readily applicable to monitoring of fluoro or halogen species in various industrial process operations generating such species, including semiconductor manufacturing operations such as chamber cleans, in which fluoro or halogen species are utilized for removing silicon oxides, silicon nitrides, tantalum oxides, and low dielectric constant (k<3.9) silicon-containing films such as carbon-doped silicon oxides, etc.

A variety of designs are possible for the gas sensing assembly, and an array of devices of different dimensions may be advantageously employed to maximize the efficiency of the gas sensor assembly, in respect of generation and outputting of a plurality of signals for the monitoring of the one or more target gas species in the fluid environment being monitored by the assembly.

It will be recognized that micro-hotplate embodiments of the gas sensing assembly may be widely varied in respect of the component sensing films and reactive/sorptive chemistries employed, as determinable within the skill of the art for a given end use application of target gas species detection. Micro-hotplate detectors may be fabricated as more fully described in U.S. Pat. No. 6,265,222 issued Jul. 24, 2001 in the names of Frank DiMeo, Jr. and Gautam Bahndari, the disclosure of which hereby is incorporated herein by reference in its entirety.

The present invention in another embodiment contemplates a gas sensor including a thermal isolation structure with a catalytic surface and an embedded heater and temperature sensor, in which the heater can be a resistor or transistor element, and the temperature measurement is performed by a thermopile, a thermistor, or a thermoelectric element.

The temperature increase by exothermic reactions can be detected by temperature measurement apart from a nickel pellistor, which functions as a catalyst/heater/thermistor. Due to the relatively high conductivity of nickel metal, it may be desirable in some instances to decouple the heating and thermistor functions. This can be done in a number of ways.

A microhotplate arrangement can be employed, with a catalytic surface coating. With respect to materials, SiC and Ni may be usefully employed in EPM applications as materials exhibiting high stability against fluorine corrosion. The catalytic layer need not be electrically connected. A resistive material with a large temperature coefficient of resistivity is desirable for performing the heater/thermistor function. Polysilicon is an excellent material for such purpose. Ideally, the heater operates to maintain a constant temperature, with the variation of joule heating to maintain such constant temperature being indicative of surface catalytic reaction. Alternatively, the temperature can be a floating variable, with the heater being operated at a fixed voltage/current/power, whereby the resulting variation in temperature is indicative of surface catalytic reaction.

Temperature measurement can be carried out using embedded thermopiles, e.g., in the form of polysilicon/nickel junctions.

In another variation, the pellistor transduction can be performed by the polysilicon heater/thermistor, instead of by a catalytic nickel surface layer.

In a still further variant, useful with materials having a high Seebeck coefficient, such as polycrystalline SiC (Seebeck coefficient >0.1 mV/° C.), are employed. By electrically connecting a SiC layer just under the Ni surface coating (hot) and a cold heat sink (e.g., substrate), an emf indicative of temperature difference develops, which can be used for temperature measurement.

Thus, by such approach, the electrical transduction can be decoupled from the active sensing layer, so that the catalytic nickel surface is no longer electrically active. This is a significant operating advantage. If gradual loss of nickel catalyst were to occur as a result of electrical activity, it would pose an issue in instances where the catalytic coating is initially very thin. Loss of coating would then result in drift in the readout in the absence of active fluorine species. By avoiding electrical conduction through the catalytic coating, the sensor obviates such difficulty, and thereby improves the reliability of the sensor, relative to thin-film sensors in which the catalytic coating is exposed to electrical conduction.

Such decoupling also allows separate optimization of the catalytic layer and the transducer layer to be achieved. For example, one is thereby enabled to provide very large surface area without any conductance penalty, and the thickness of the catalytic layer is non-critical for proper operation. In addition, other metals that have potentially higher recombination activity, e.g., copper, may be usefully employed. Microhotplates with and without catalytic surface can be made, and therefore differential measurement, such as Wheatstone Bridge measurement, can be made that is selective to the catalytic reaction, independent of environmental fluctuation.

In prior practice, where it was not possible to separate the environmental fluctuation from target stimulus effects, it was necessary to take a reference reading at tool start-of-clean for subsequent signal processing. Such reference reading in turn requires active communication with the tool controller, which is not always accessible. The sensor described above avoids such requirement and is truly selective to target stimulus.

The thermistor approach in particular has several added advantages. The signal conditioning is greatly simplified because of the large electrical resistance of polysilicon as compared to nickel layers. Further, polysilicon is readily compatible with existing Ni surface machining processes such as the MUSiC process commercially available from FLX MICRO (www.flxmicro.com).

The sensor thus may be configured with a nickel layer on a silicon carbide substrate, with hot and cold connections, and with the voltage difference between the hot and cold connections constituting the Seebeck emf.

A thermopile may be embedded in a Ni-coated SiC microhotplate in an arrangement that avoids passing current through the Ni coating. Rather, the pellistor operation is accomplished by tuning the hotplate temperature, with the hot plate being separated from the nickel layer. An embedded polysilicon heater can be employed to measure temperature. As another alternative, a thermoelectric approach can be employed, using silicon carbide's Seebeck voltage, with a heat sink being provided on the substrate side.

By adding a thermopile, the number of sensor connections is increased by at least 2. While the thermopile and the thermoelectric structure need contacts for temperature measurement, there is no need to make contacts to the upper nickel layer. Thus, a total of four contacts are provided (two for the heater, and two for the temperature measurement). Following a thermistor approach, the number of contacts is maintained at 2.

An etch process monitor (EPM) in one embodiment can be employed in plasma enhanced chemical vapor deposition (PECVD) oxide chambers to detect chamber clean endpoint. Chamber cleans are performed using a fluorinated etchant gas (e.g., NF₃) which reacts with deposited SiO₂ to form gas phase byproducts (mostly SiF₄ and HF). As NF₃ breaks apart in the plasma, F₂ and F− are formed. At the endpoint, all SiO₂ has been etched, limiting the reaction of F with SiO₂. This results in a change in electrical properties in the EPM. In one embodiment, the EPM uses an electroplated nickel silicon carbide filament. This filament has a low heat capacity and a semiconductive core, which enables the EPM to provide faster, more reliable chamber clean signals. The filament can be arranged in such embodiment to span a KF40 flange. Each end of the filament is connected to an electrical feed through by which electrical power is supplied and electrical properties are measured. During chamber cleans, the resistance of the nickel plated silicon carbide filament is held constant. At the endpoint, the resistance of the filament increases. To compensate for this change in resistance, the current applied to the filament decreases. This is the signal for chamber clean endpoint.

In general, it is desirable to maintain the footprint of the etch process monitor as small as possible. The small the sensor, the closer it is possible to install the sensor to the process chamber. For example, the process chamber may be a P5000 process chamber commercially available from Applied Materials, Inc., (Santa Clara, Calif.), and the fabrication of the sensor with a ⅜″ inch NPT plug allows the sensor to be directly installed into a port on such process chamber. The sensor may employ, in one embodiment, a micro-machined filament, with the sensor being fabricated on a ¼″ inch NPT or other suitable fitting, to minimize the footprint of the sensor.

Reducing the footprint of the sensor makes it possible to install the sensor at the closest possible downstream position in relation to the process chamber.

In some instances, it may be desirable to modify the process system to accommodate the etch process monitor. For example, using a P5000 process chamber, it may be desirable to relocate the P5000 throttle valve to a point farther down the chamber exhaust line, with the etch process monitor being located upstream of the throttle valve. Such arrangement allows the etch process monitor to be disposed in an environment in which the pressure is equal to the pressure in the process chamber, while providing an appropriate footprint for installation of the etch process monitor. The closer the etch process monitor is to the chamber, the more accurate the endpoint detection signal becomes. The micro-machined etch process monitor in one embodiment can comprise a configuration that is able to be installed without any major system modifications.

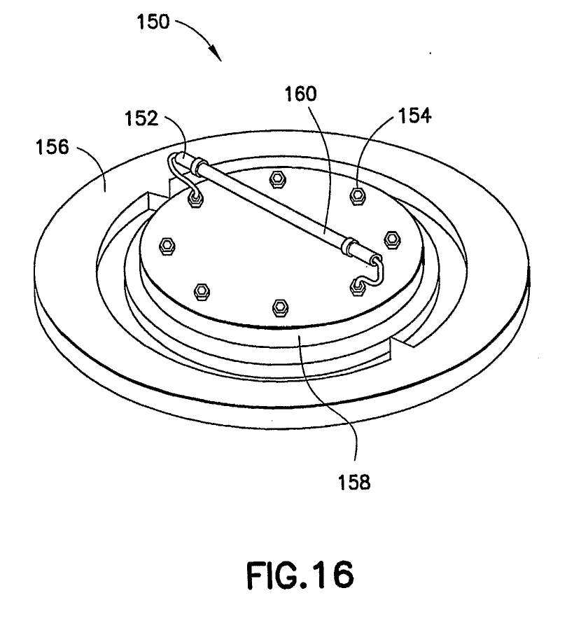

FIG. 16 is a perspective view of a sensor assembly in which the sensor assembly 150 includes a 2.16″ diameter KF40 flange 156, on which is mounted a Vespel® material disk 158. The disk 158 is secured to the flange 156 by press fit pins 154. The sensor element 160 includes a silicon carbide filament that is electroplated with nickel film, such filament structure being secured in position by the press fit pins 152 associated therewith. In this sensor, as illustrated, the electroplated nickel silicon carbide filament is horizontally oriented.

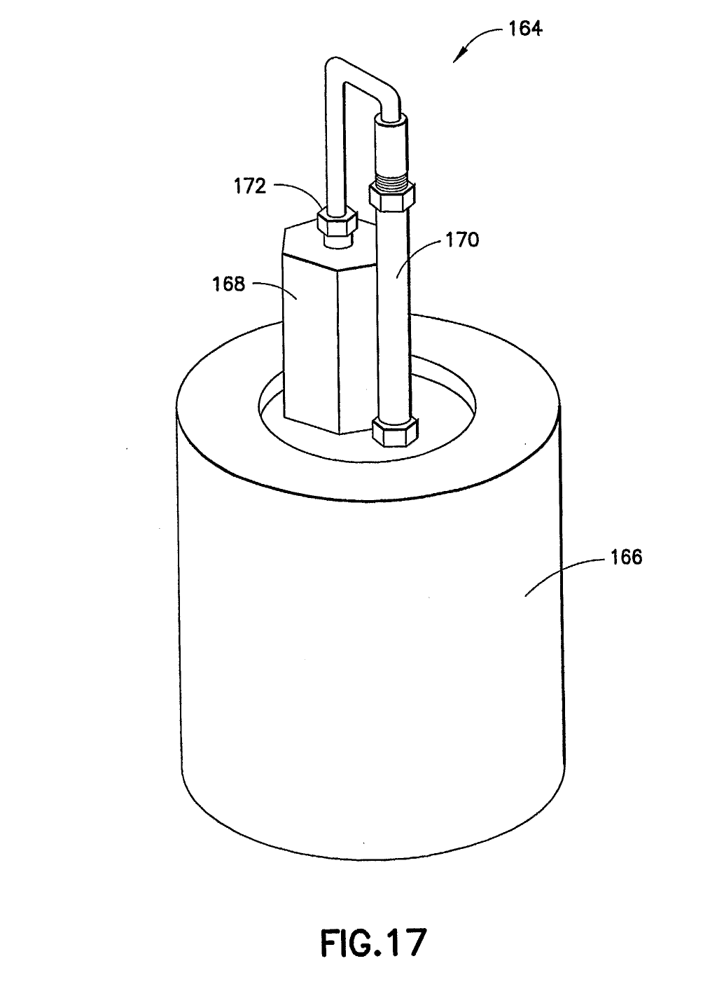

FIG. 17 is a perspective view of a sensor 164 according to another embodiment of the invention. The sensor 164 incorporates a filament 170 that is vertically oriented, to minimize the required footprint for the sensor. Such reduced footprint enables ready installation into a ⅜″ NPT tapped hole in a P5000 process chamber, such tapped hole being an original feature of such chamber.

The filament 170 in the FIG. 17 sensor 164 is a silicon carbide filament that is electroplated with a nickel film. Utilizing two differently sized press fit pins to make electrical contact, the filament is installed in a machined insert 168 formed of Vespel® material. The machined Vespel® insert is installed in a ⅜″ NPT fitting 166. This vertical orientation and arrangement reduces the footprint of the sensor from the 2.16″ diameter that is characteristic of the FIG. 16 sensor, to a footprint of 0.675″, a 70% decrease.

The machined Vespel® material insert 168 is secured to the NPT fitting 166 in any suitable manner, e.g., using press fit pins and TORR-SEAL sealant, or other sealant medium. The press fit pins are pressed through the Vespel® insert, and then through the metal flange associated with the sensor assembly. Recommended hole diameters are employed based on pin specifications. The sealant medium should ensure a vacuum seal against process gases.

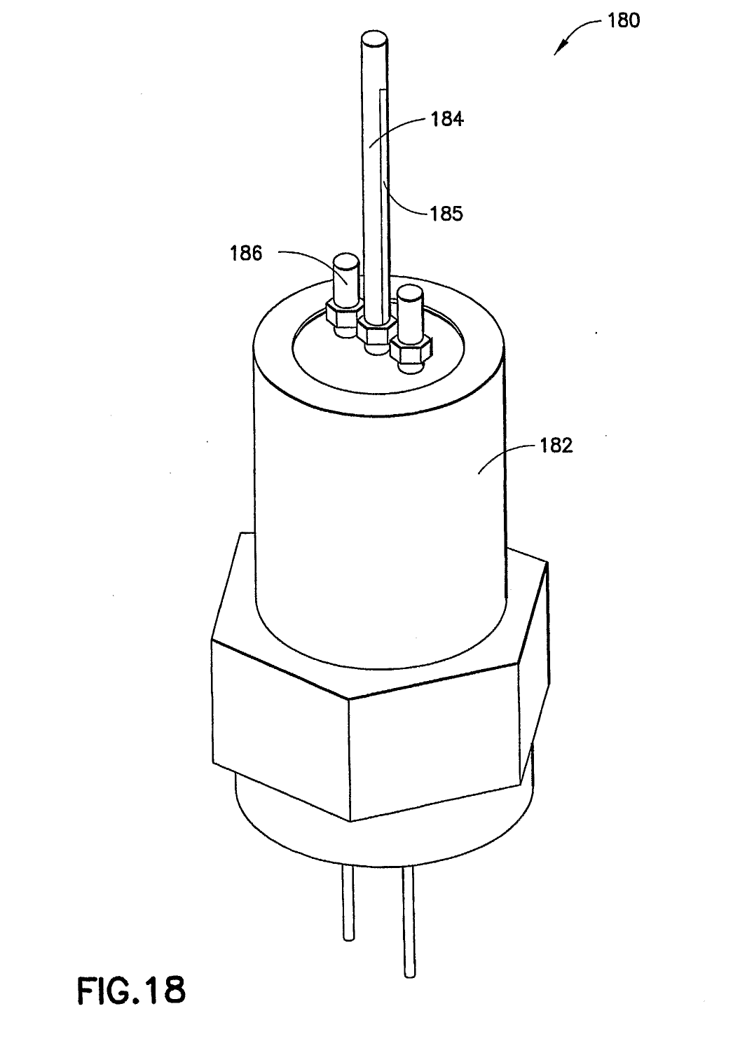

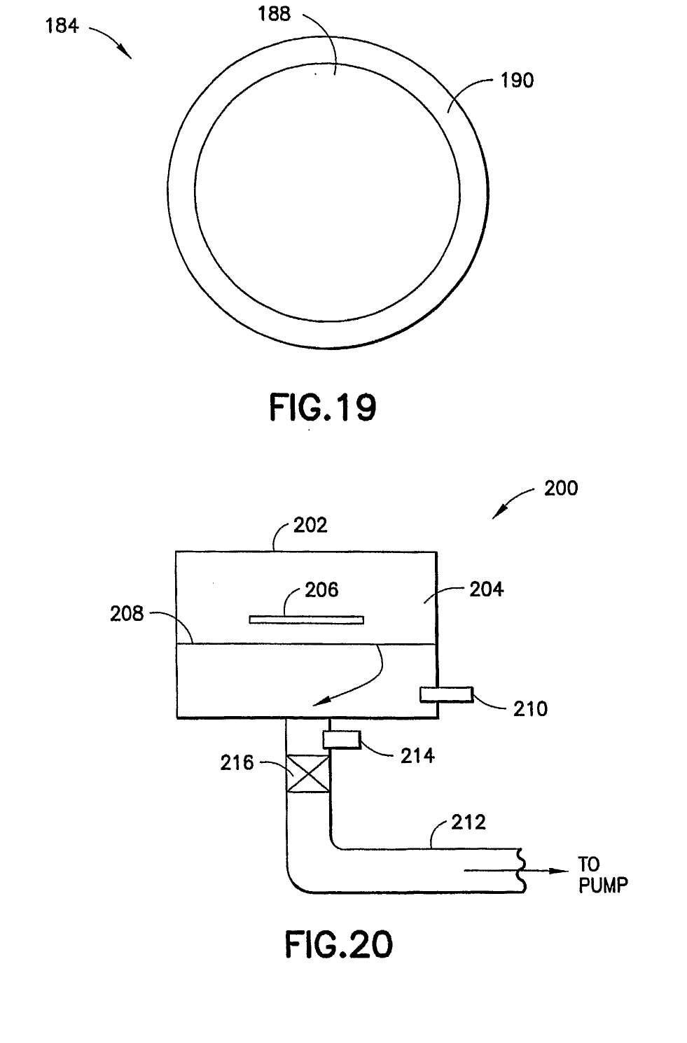

In another embodiment, the sensor may be fabricated as shown in FIGS. 18 and 19. FIG. 18 is a perspective view of a sensor 180 and FIG. 19 the corresponding top plan view of such sensor. The sensor filament 184 in this embodiment may have a length of 0.5″ and a diameter of 142 microns, with the filament being mounted on a ¼″ diameter NPT fitting 182. For example, the micro-machined etch process monitor can be installed in a process chamber using a ⅜″ NPT tapped hole. The micro-machined etch process monitor shown in FIGS. 18 and 19 is approximately 25% of the size of the etch process monitor shown in FIG. 16. Such size permits the sensor to be located at the closest possible position to process gases exiting the process chamber, thereby enabling the earliest possible endpoint detection.

In the FIG. 18 micro-machined sensor, the filament 184 has a 0.4″ long, 25 micron wide, 2 micron deep laser ablated channel 185. Press fit contacts 186 are employed to secure nickel wires in relation to the filament.

The use of an electroplated nickel film over a silicon carbide filament combines a durable, non-reactive core material with a reactive metal thin film that changes in electrical properties at the chamber clean endpoint. The silicon carbide filament can be electroplated with nickel, or coated with a metal film in any other suitable manner. Subsequent to the nickel deposition, a channel is removed in the filament. Such channel removal may be effected in any suitable manner, e.g., by photolithographic technique, laser ablation, etc. In a specific embodiment, a laser is used to remove the channel. Prior to such “channelizing,” the coated filament has the form shown in the top plan view of FIG. 19, wherein the filament 184 features a circumferentially continuous and uniform thickness coating of nickel 190 on the outer surface of the silicon carbide filament core 188.

The channels in the electroplated metal film may be made 180 degrees apart from one another, so that the channels are diametrically opposite one another. The purpose of such arrangement of channels is to create legs in the metal film that form the electrical path of the filament.

The electroplated metal may be powered using an industrial personal computer and software designed specifically to operate the etch process monitor. The resistance of the electroplated metal film is recorded initially and entered in the software record. The filament then is controlled to that resistance. Current is applied to the filament during all process chamber cycles. During the chamber clean, the sensor current rises to control the resistance setpoint and stabilizes. As the chamber clean endpoint is achieved, the electrical properties of the metal film change. To control the filament at the set resistance value, the software functions to adjust the current applied to the sensor. Such change in current applied to the filament corresponds to the chamber clean endpoint.

To further electrically isolate the nickel thin film, thin films could be used as barrier layers between the nickel thin film and the silicon carbide filament, to increase the response of the sensor, as well as to protect the filament from shorting at high operating temperatures.

With an increase in temperature, the conductivity of semiconducting silicon carbide-increases, rendering the filament susceptible to a possible short. For example, if an aluminum oxide thin film is deposited as a barrier layer between the nickel thin film and the silicon carbide filament, the nickel film is electrically isolated from the filament. The nickel thin film typically is deposited using electrodeposition. If a non-conductive barrier layer is deposited on the surface of the silicon carbide filament, methods of nickel deposition other than electrodeposition may be required, such as e-beam deposition or sputter deposition.

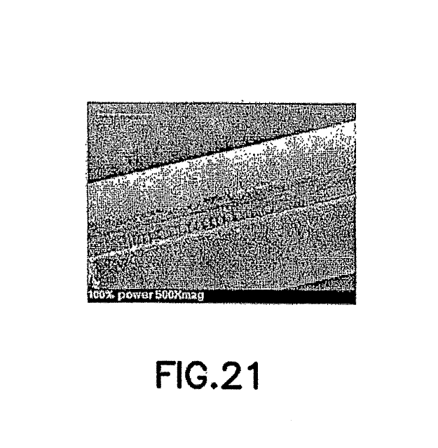

FIG. 21 is a micrograph, at 500 times magnification, of a sensor filament in which electroplated nickel has been removed to form a channel. The channel in this instance is 25 microns wide and 2 microns deep in the 2 micron thick electroplated nickel film plated on a 142 micron diameter silicon carbide filament.

FIG. 20 is a schematic representation of a process system 200 in which a sensor is mounted. The process system 200 includes a P5000 chamber 202 enclosing an interior volume 204 in which is disposed a process wafer 206, above the pumping plate 208. The process chamber 202 is coupled with an exhaust line 212 connected to a pump, as shown by a directional arrow (TO PUMP). The exhaust pump 212 contains a throttle valve 216.

In this configuration, a sensor 214 of the type shown in FIG. 16 may be disposed in the exhaust line upstream of the throttle valve 216, as shown.

Alternatively, however, and preferably, a low-footprint sensor 210 of the type shown in FIGS. 17 and 18 is mounted in the process chamber wall below the pumping plate 208, as shown. Such arrangement, for example, may be effected with a sensor having a ⅜″ NPT fitting that is matably engageable with a ⅜″ NPT tapped hole in the sidewall of the process chamber 202. Such tapped hole enters the chamber below the pumping plate 208. The pumping plate 208 is used to uniformly and evenly pump process gases from the process chamber. All gases entering the chamber (introduction means not shown) are removed through holes in the pumping plate, which may for example be ¼″ in diameter and dispersed across the surface of the plate. Below the pumping plate is a trough that is connected to the exhaust line of the chamber. By disposing the low-footprint sensor 210 in the ⅜″ NPT tapped hole, the sensor is positioned in sensing relationship in the trough below the pumping plate, downstream of the wafer and gas introduction. In this location, the sensor does not interfere with any moving parts in the process chamber.

Electrical connections to the micro-machined etch process monitor may be made in any suitable manner, e.g., by mechanical connection, electroplating connection, wire bonding connection, etc. A mechanical connection made be made using 2 legs in the filament, with individual mechanical connections being made to each leg of the filament. The mechanical connection may for example include a clamp that is secured to each leg of the filament using set screws or other mechanical fasteners. A large press fit connection could be tapped 180 degrees apart, with set screws serving to secure the filament in the press fit connection.

Another approach would be to electroplate the legs of the filament to a silicon carbide base, wherein the silicon carbide base is a thin disk containing two nickel plated lines. Plating such lines may be effected utilizing photolithographic techniques. Once the base is fabricated, the micro-machined etch process monitor filament is mechanically attached to the disk. The legs of the filament are in contact with the nickel-plated lines on the silicon carbide base. Feedthroughs below the silicon carbide base would be necessary to connect power to the electroplated lines on the base.

A wire bonding technique could be employed to bond thin nickel wires to each leg of the filament, with connection of the thin nickel wires to a press fit connection.

A variety of metals may be employed for filament coating and thermocouple formation.

Copper is an acceptable fluorine-resistant material of construction for fabrication of the etch process monitor. Considering fluorine resistance generally, the fluoride film formed due to fluorine exposure must be dense and have low vapor pressure. While such properties are not well known, one may use melting point as a guide. Many elements form single fluoride phases having melting points that are above the melting point of copper difluoride (˜785° C.). Elements having multiple phases may form fluorides that are non-stoichiometric and less fluorine-resistant than those having a single phase. For elements that are metallic and non-combustible under atmospheric conditions, the following elements form single fluoride phases (with the melting point of the fluoride in each instance being listed in parenthesis):

### Group IIA

Mg (1248), Ca (1418), Sr (1477), Ba (1368)

### Group IIIA

Al (1290), Ga (>1000)

### Group IIB

Zn (872), Cd (1049)

### Group IIIB

Sc (1515), Y (1150)

### Lanthanides

La (1493), Nd (1374), Gd (1231), Dy (1154), Ho (1143), Er (1140), Tm (1158), Lu (1182)

### Group VIII

Ni (1450)
Gd has the highest electrical resistivity among the foregoing species (20 times that of Ni) and is a preferred species for coating.

In addition to their use as materials for coating of filament, thermocouple junctions useful for etch process monitor applications can be fabricated using any two of the foregoing materials or their alloys.

Any suitable material may be employed for forming the core fiber of the sensor filament. In one embodiment of the invention, alumina is employed as a substitute for silicon carbide. Useful alternative materials include sapphire monofilaments commercially available from Goodfellow Corporation, Devon, Pa. (A1665920 sapphire monofilament), sapphire optical fiber commercially from Photran, LLC, Poway, Calif., and chopped fibers commercially available from 3M Company, St. Paul, Minn., as Nextel 610 chopped fibers.

Alumina is a highly suitable fluorine-resistant material.

The filament core may be formed of any suitable materials, including compounds of elements and alloys discussed hereinabove, including, without limitation, fluorides, oxides and nitrides.

Any suitable filament composition can be employed that is able to be coated with a thin conductive coating. ZBLAN fibers commercially available from various vendors may be employed, as well as MgO and MgAl₂O₄ fibers. MgO has been verified as a highly suitable fluorine-resistant material. As a balance of various cost and performance considerations, Al₂O₃ is highly preferred.

The filament core can be less than fully coated without adverse effect on performance of the sensor. Such relaxation of full coating coverage requirements substantially increases the degrees of freedom in design and fabrication of the sensor.

Plating can be avoided as a coating technique, in favor of use of other techniques, such as vacuum deposition techniques, e.g., e-beam or sputtering techniques, for depositing a metal layer such as nickel on alumina monofilament.

Mass coating of hundreds of monofilaments in one vacuum deposition is readily achieved, with a very high degree of uniformity.

In addition, the relaxation of the continuity requirement for the metal coating means that a thick coating is no longer required, in the case of alumina as the core material, because bare alumina monofilament is highly resistant to fluorine plasma. The layer of deposited metal can be as thin as 20 nm, two orders of magnitude thinner than a typical nickel coating on SiC monofilament. In the case of Nextel 610 chopped fibers (commercially available from 3M Company, St. Paul, Minn.), the available diameters range from 7 to 13 microns, whereby another factor of 10 reduction in diameter is achievable. Such thin coating in turn boosts the filament resistance by a factor of 100-fold, to several hundred ohms (1000-fold for Nextel fibers), thereby greatly simplifying the measurement electronics required for the sensor. Furthermore, one can reduce filament length for small host flanges without the necessity of resorting to wishbone or other geometrically complex configurations.

With a large electrical resistance, the filament can be operated in a constant current mode instead of a constant resistance mode, since it is unnecessary to operate with constant resistance to boost signal strength. The use of constant current as an operating modality means that the filament can be operated as a resistance temperature detector (RTD), thereby eliminating the need for expensive circuitry components (e.g., voltage-controlled current source) and complex feedback control. Conventional bridge circuitry therefore can be readily employed. Alternatively, the circuitry for constant resistance operation can be retained and depending on the use conditions, the sensor can be operated in a constant current mode (as an RTD sensor) or in a constant resistance mode (as an anemometric sensor). This flexibility of operation will allow the same sensor configuration to operate in over-and under-clean conditions. Finally, such arrangement permits multiple elements to operate in different modes and at different settings to provide differential/redundant signals for accurate data interpretation.

In another embodiment, the Ni-coated SiC monofilament is replaced by micromachined nickel or copper structure on an alumina substrate. Nickel or copper on alumina filament is commercially available (see http://www.microfabrica.com/resource_center/EFAB_White_Paper_Microfabrica.pdf).

In a further embodiment, the invention contemplates a micromachined Ni pellistor sitting on with an alumina support. In addition, a thermally isolated RTD sensor using a single metal, such as nickel, and a thermojunction (such as nickel/copper), may be provided.

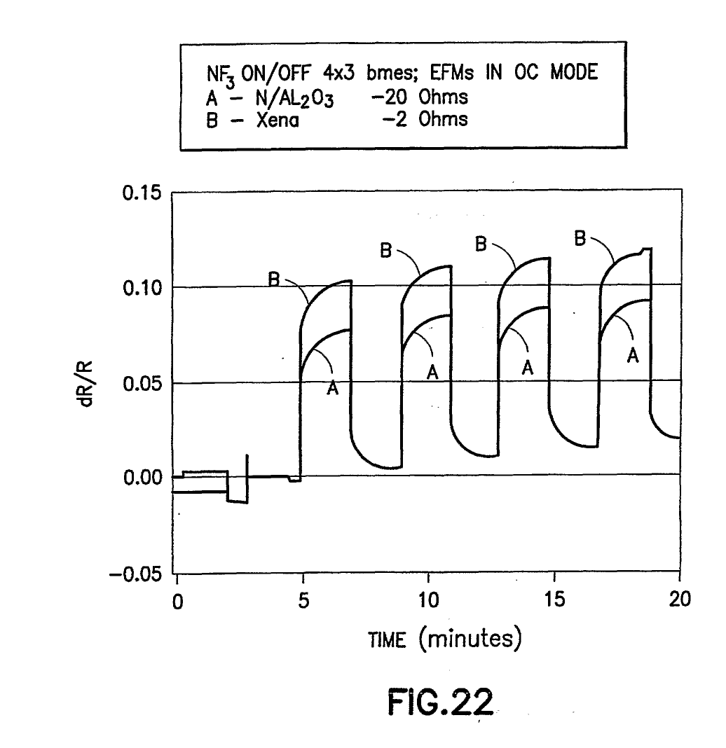

FIG. 22 is a graph of change in electrical resistance, as a function of time, for a comparison test of iron wire and nickel coated alumina (curve A) and a horizontally mounted nickel-coated SiC carbon fiber (XENA) (curve B). The respective curves show the resistance change while the etch process monitor was operated in a constant current mode in a cycle involving intermittent exposure to nitrogen trifluoride, and on/off operation in which four events of nitrogen trifluoride exposure were alternated with three off cycle steps.

Considering another aspect of the present invention, stainless steel is used in process tools that must accommodate exposure to highly corrosive fluorine species generated by plasma. As such, stainless steel (SS) is among the acceptable materials of construction for devices exposed to fluorine. SS-sheathed temperature-measuring elements, e.g., thermocouples, RTDs, and thermistors, are commercially available at low cost. Adoption of SS sheathing effectively expands the list of compatible materials available for fabrication of sensors according to the present invention, since the sheath provides additional protection to the element that otherwise may be etched by fluorine.

Use of sheathed elements has the added advantage of allowing one to weld the sheath directly to the host flange in place of a dedicated electrical feedthrough. The sheath can be welded to the EPM host flange directly. Alternatively, the flange that not infrequently accompanies the sheathed elements (for example, Omega RTD-800 series RTD temperature probes and the Lorex flanged/sheathed thermocouples) can be welded to the EPM host flange. Such welding, while a customized modification, is readily effected and involves no significant added expense to the cost of the sensor.

While stainless steel is a popular sheath material, any other suitable materials may be employed as a sheathing material, as for example Inconel and Hastelloy-C. Many such alloys contain higher nickel content (generally >50 atomic %) than stainless steel (<15 atomic %). Many of such alloys are more fluorine-resistant than stainless steel, when passivation occurs, e.g., a passivating nickel fluoride layer forms on the alloy surface when the alloy sheath is exposed to fluorine, and such passivating layer prevents further corrosion. While sheath materials preferably contains a high nickel content to enhance fluorine-resistance, suitable enhancement can be achieved by applying a nickel surface coating to the sheath.

A tabulation of corrosion resistance of alloys is available at http://www.watlow.com/reference/files/corrosion.pdf.

In general, the utilization of a sheath entails a penalty of slower response time. It therefore is preferred to use thin-walled, grounded sheathing elements. Alternatively, a thin layer of insulating, fluorine-resistant material such as aluminum oxide, or fluoro-polymers such as TEFLON, VESPEL, and KAPTON, can be deposited. The survivability of TEFLON and VESPEL in fluorine environments has been empirically confirmed. In one embodiment, a metal sheath (which is typically >20 microns in thickness) can be replaced by, for example, an aluminum oxide coating of 2 microns thickness. Comparatively, the unsheathed, insulating coating arrangement has additional thermal mass and is therefore susceptible to faster response than the metal-sheathed arrangement.

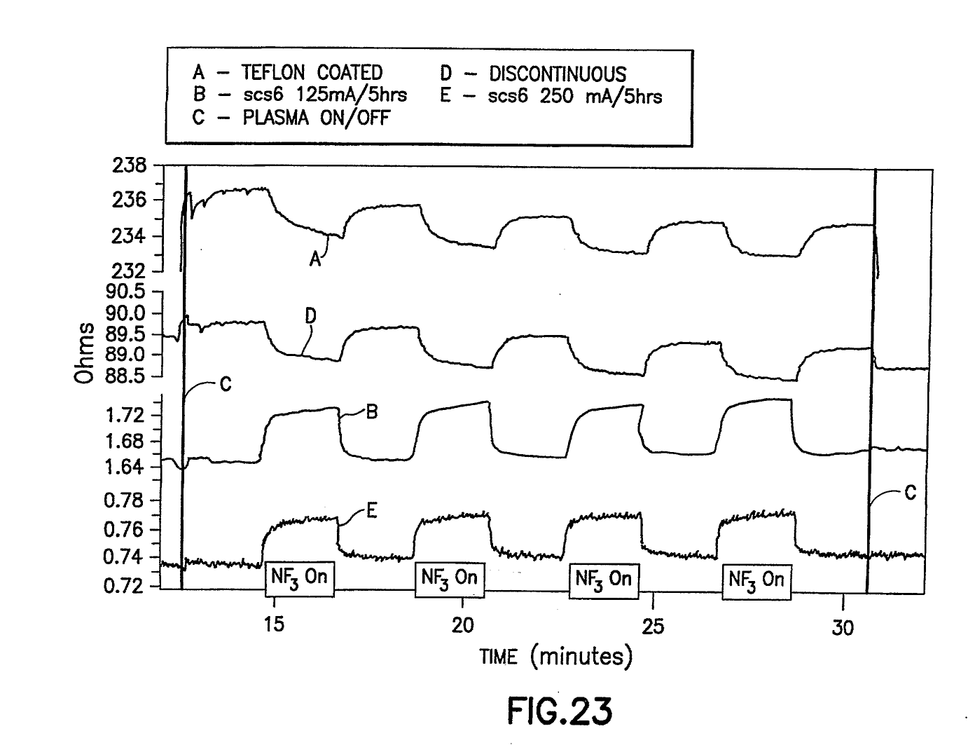

FIG. 23 is a graph of resistance, in ohms, as a function of time, in minutes, showing the response of a Teflon-coated nickel plated SiC filament (curve A), a discontinuous nickel plated silicon carbide filament (curve D), a nickel plated SiC filament plated at a current of 0.125 milliamps for 5 hours (curve B) and a nickel plated SiC filament plated at 0.25 milliamps for 5 hours (curve E), with curve C representing the plasma on/off cycle. The test conditions involve simultaneously testing all four filaments in a constant current mode. Process conditions included a pressure of 5 torr with a flow rate of 800 standard cubic centimeters per minute (sccm) of argon and 400 sccm nitrogen trifluoride, with the process being operated by turning on and off four times to simulate endpoint or fluorine rise.

It was observed that the Teflon coated sample and the discontinuously coated filament had opposite responses. Resistance decreased with the introduction of fluorine.

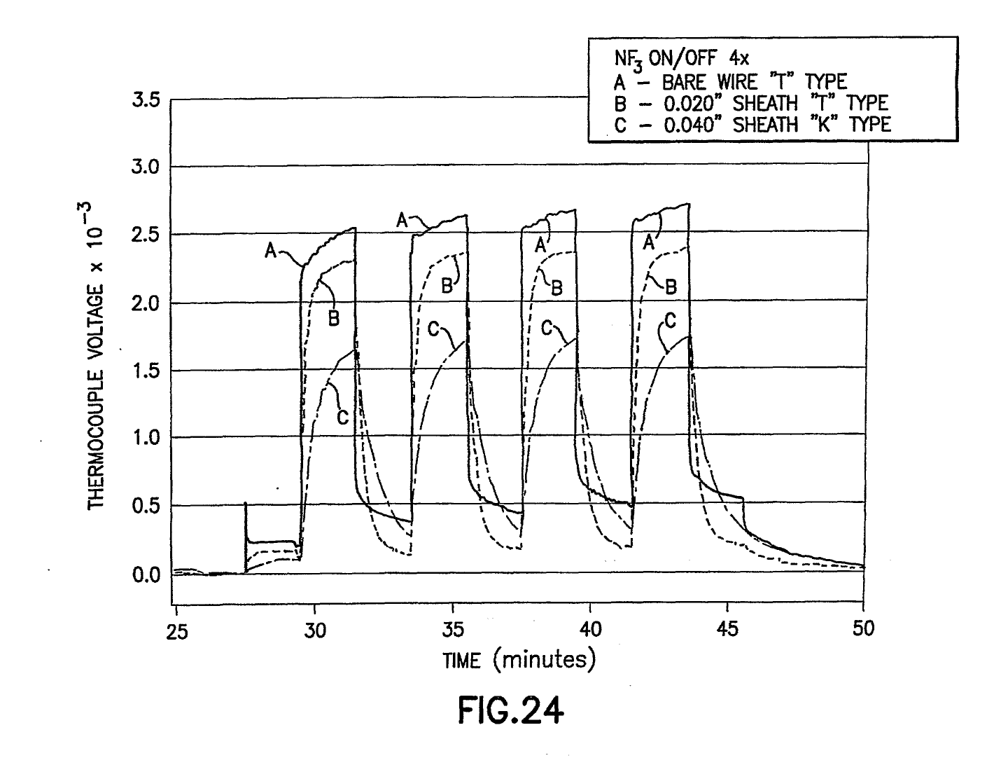

FIG. 24 is graph of thermocouple voltage as a function of time, for a test in which three thermocouples were examined under exposure to 4 pulses of nitrogen trifluoride. A bare wire T-type filament had the fastest response (curve A). Curve B is the curve for a 0.020″ sheathed T-type filament and curve C is a 0.040″ sheathed K-type filament. If sheathed, elements that are otherwise vulnerable to fluorine such as K-type thermocouples can be usefully employed, however, sheathing increases response time in general correlation to the thickness of the sheathing layer.

The sensors of the present invention may be employed with any suitable endpointing algorithms.

In one embodiment, the governing equation, in a minimal and differential form, can be written as

ΔW+{h(k, v)×ΔT_{effluent}+Tₑₗₑₘₑₙₜ×Δ[h(k, v)]}+ΔH·r=0

where ΔW is the necessary change in joule heating to maintain the sensing element at a set temperature Tₑₗₑₘₑₙₜ; h is the heat convection coefficient and is a function of effluent thermal conductivity k, kinematic viscosity v, and other factors; T_{effluent} is the effective effluent temperature; ΔH is the enthalpy of reaction (e.g., recombination of fluorine radicals) that occurs on the element surface, and r is the reaction rate.

ΔW is measured and thus known in real time. The two terms in the curly brackets represent changes in convection loss and are dependent on k and v. The etch products tend to have low thermal conductivity and kinematic viscosity when compared with the etchant (e.g., F₂), as shown in Table A below:

TABLE A

| Species | WF₆ | CF₄ | SiF₄ | BF₃ | HF |
|---|---|---|---|---|---|
| Thermal | 9.8 | 15.0 | 15.6 | 16.6 | 23.0 |
| conductivity | | | | | |
| (mW/m · K) | | | | | |
| Kinematic | 0.6 | 1.96 | 1.5 | 2.5 | 5.8 |
| viscosity | | | | | |
| (μpoise/g)* | | | | | |

*Kinematic viscosity is defined as the ratio between dynamic viscosity and density. Because the density ratio varies with pressure and therefore is not a fundamental material property, the molecular weight is used in place of density.

Because the etching reactions are exothermic, the effluent temperature is high during clean as compared with post-clean operation. The trending behavior of each term as the clean progresses can be described as

ΔW=−{h×ΔT_{effluent}↓+Tₑₗₑₘₑₙₜ×Δh↑+(ΔH·r)↑}

Because the relative weighing of these terms varies from one clean process to the next, it is not known a priori how to determine an endpoint and therefore a deterministic algorithm is not feasible.

For normal tool operation, while a deterministic algorithm is not feasible, a generic algorithm with field-selectable parameters is possible. The following generic representation of the governing equation therefore has utility in considering general trending:

W=Term 1↑+Term 2↓

Depending on the relative weighing of these two terms, there can be four-and only four-possible scenarios: (1) Term 1 dominates throughout the clean cycle, (2) Term 2 dominates throughout the entire clean cycle, (3) Term 1 dominates and initially and gives way to Term 2 in subsequent operation, and (4) Term 2 gives way to Term 1 in the course of operation. A pictorial description of each scenario is set out below:

[symbol]

A generic algorithm with selectable conditions can be developed to locate the endpoint for any one of these four scenarios. The following four parameters are first defined, each a function of time during the clean process:

S_{M}(t)≡max[W(t)]−W(t)

S_{M}(t)≡W(t)−min[W(t)]

where the subscripts max and min indicate the maximum and minimum values since the Start of Clean (t=0). Generic algorithms may be constructed based on these parameters or functions of these parameters. An example is presented as a two-stage conditional decision process:

| Scenario | Pre-condition | Condition |
|---|---|---|
| (1) | None | Sₘ > threshold |
| (2) | None | S_{M} > threshold |
| (3) | Sₘ > pre-threshold | S_{M} < threshold |
| (4) | S_{M} > pre-threshold | Sₘ < threshold |

Endpoint is reached when the conditions are met. The pre-condition is designed to accommodate the change in relative weighing between the two terms that categorizes the third and fourth scenarios. The pre-threshold value, if chosen judiciously, will also allow multiple peaks (rippling in appearance) if the residue to be removed is made up of layers of different chemical compositions. A pre-condition is not required for the first two scenarios.

In field deployment, an operator defines the endpointing algorithm by the steps of:
1. Selecting the pre-condition parameter: none, SM, or SM
2. Selecting the pre-threshold value, if required
3. Selecting the conditioning comparison: larger than (>) or smaller than (<)//this can be included with Step 1 as the pre-condition defines the conditioning comparison as well
4. Selecting the threshold value

The 4-step selection process described above can be automated provided that the software is able to determine which category accommodates the measured traces, it being noted that the clean process must be repeatable in character. Sophisticated pattern recognition techniques can be employed, or parameters at the end of the clean can be examined for overclean processes (i.e., clean processes that reach the endpoint, e.g., by using an auxiliary analytical instrument or an intentional extension of the clean time):

| Conditions (at end of clean) | Scenario |
|---|---|
| Sₘ}} S_{M} ? 0 | (1) |
| S_{M}}} Sₘ ? 0 | (2) |
| S_{M}}} Sₘ > 0 | (3) |
| Sₘ}} S_{M} > 0 | (4) |

It is therefore conceivable that, after the setpoint setup stage, the software moves to a training stage where (over-) clean processes are run multiple times for the software to categorize the traces and identify proper threshold values:
1. Record the power traces value for a few over-clean cycles.
2. Categorize the traces by the following conditions: (“Zero” is a non-zero value to determine the mathematically meaningful but algorithmically vague “?” condition)

| Conditions (at end of clean) | Scenario |
|---|---|
| Sₘ > Zero > S_{M} | (1) |
| S_{M} > Zero > Sₘ | (2) |
| S_{M} > Sₘ > Zero | (3) |
| Sₘ > S_{M} > Zero | (4) |

It is desirable that all processes yield the same end results.
3. Identify the end-of-(over) clean parameter values of interest from these cycles:

| Scenario | Parameters of interest |
|---|---|
| (1) | Minimal Sₘ |
| (2) | Minimal S_{M} |
| (3) | Minimal Sₘᵢ and maximal S_{M} |
| (4) | Minimal S_{M} and maximal Sₘ |

4. Determine pre-threshold and threshold values based on the parameter values from the previous step with a safety margin Δ allowed. This strategy helps ensure the endpointing conditions will be met most if not all times.

| Scenario | Prethreshold definition | Threshold definition |
|---|---|---|
| (1) | None | Subtracting Δ from minimal |
| | | Sₘ |
| (2) | None | Subtracting Δ from minimal |
| | | S_{M} |
| (3) | Subtracting Δ from minimal Sₘ | Adding Δ to maximal S_{M} |
| (4) | Subtracting Δ from minimal S_{M} | Adding Δ to a from |
| | | maximal Sₘ |

The endpoint calling with a built-in safety margin is designed to call the endpoint somewhat prematurely to accommodate process variation. Therefore it may be beneficial to add a short post-endpointing period T to continue cleaning past the called endpoint.

If there is minor variation in the clean process, steps 3 and 4 can be made a resident part of the continuing operation.
3. Identify the parameter values of interest from all preceding cycles:
4. Update the threshold value(s) if the parameter values of interest come within a set boundary of the current threshold values.

The software is adapted to generate an entry on the event log to document the setpoint change when it occurs, so that, when appropriate, the tool operator can examine the appropriateness of the threshold value change. Threshold values should also be re-examined whenever the control setpoint is modified.

Although the invention has been variously described herein with reference to illustrative embodiments and features, it will be appreciated that the embodiments and features described hereinabove are not intended to limit the invention, and that other variations, modifications and other embodiments will readily suggest themselves to those of ordinary skill in the art, based on the disclosure herein. The invention therefore is to be broadly construed, consistent with the claims hereafter set forth.

1-26. (canceled)

27. A sensor comprising:
a thermal isolation structure;
a catalytic material;
a heater; and
a temperature sensor;
wherein:
the temperature sensor comprises at least one of a thermopile, a thermistor, and a thermoelectric element;
the catalytic material is catalytically interactive with a fluid to effect reaction of the fluid producing a heat effect;
the temperature sensor is adapted to sense the heat effect and produce a correlative output indicative of presence and/or concentration of the fluid contacting the catalytic material; and
the thermal isolation structure is arranged to at least partially restrict heating of the catalytic material by the heater.

28-55. (canceled)

56. A sensor adapted to sense a fluid in a stream of effluent, said sensor including a temperature sensing element and a fluid interaction element with which the fluid reacts to product a thermal response detectible by the temperature sensing element, wherein the sensor is heated by joule heating by a heater, and is adapted for operation in accordance with the relationship
ΔW+{h(k, v)×ΔT_{effluent}+Tₑₗₑₘₑₙₜ×Δ[h(k, v)]}+ΔH·r=0
where ΔW is the necessary change in joule heating to maintain the sensing element at a set temperature Tₑₗₑₘₑₙₜ; h is the heat convection coefficient and is a function of effluent thermal conductivity k, and kinematic viscosity v; T_{effluent} is the effective effluent temperature; ΔH is the enthalpy of reaction that occurs on the sensing element surface, and r is the reaction rate.

57-58. (canceled)

59. A sensor comprising a first support structure, a second support structure that is elevated relative to the first support structure, and at least one transition metal- or noble metal-containing sensing element positioned in contact for fluid sensing, wherein the at least one sensing element is supported between the first support structure and the second support structure.

60. The sensor of claim 59, wherein the at least one sensing element is disposed substantially perpendicular to the first support structure.

61. The sensor of claim 59, wherein the at least one sensing element has at least one dimension less than 150 μm.

62. The sensor of claim 59, wherein the at least one sensing element has at least one dimension less than 25 μm.

63. The sensor of claim 59, wherein the at least one sensing element comprises a filament.

64. The sensor of claim 59, wherein the sensing element comprises nickel.

65. The sensor of claim 59, wherein the at least one sensing element comprises a nickel wire or filament.

66. The sensor of claim 59, wherein the at least one sensing element comprises a nickel coating dis6posed over a silicon carbide core.

67. The sensor of claim 59, wherein the at least one sensing element is responsive to the presence of fluoro or halogen species.

68. The sensor of claim 59, wherein the first support structure has an associated first electrical contact and the second support structure has an associated second electrical contact, with said first contact and said second contact being adapted to secure the sensing element.

69. The sensor of claim 59, including a temperature sensor comprising at least one of a thermopile, a thermistor, and a thermoelectric element.

70. The sensor of claim 59, arranged to determine end point of a chamber cleaning operation by change of electrical properties of the sensing element.

71. A chemical process assembly including a chamber adapted for flow of a process material therethrough, and including the sensor of claim 59, adapted to sense a fluid present in the process material.

72. The assembly of claim 71, wherein the sensor includes a flange or plug adapted for mating with the chamber.

73. A semiconductor processing control system comprising the sensor of claim 59.

74. A method of sensing a fluid in a stream of effluent containing or susceptible of containing the fluid, the method comprising use of a sensor having a first support structure, a second support structure that is elevated relative to the first support structure, and at least one nickel-containing sensing element positioned in contact for fluid sensing, wherein the at least one sensing element is supported between the first support structure and the second support structure.
